(19) United States
(12) Patent Application Publication
(10) Pub. No.: US 2026/0289432 A1
(43) Pub. Date: Sep. 24, 2026

(54) SYSTEM

(71) Applicant: SoftBank Group Corp., Tokyo (JP)

(72) Inventor: Yuki SHINOTSUKA, Tokyo (JP)

(73) Assignee: SoftBank Group Corp., Tokyo (JP)

(21) Appl. No.: 19/567,069

(22) Filed: Mar. 14, 2026

(30) Foreign Application Priority Data
Mar. 19, 2025 (JP) 2025-045237

(51) Int. Cl. G06Q 10/02

(52) U.S. Cl. CPC G06Q 10/02

(57) ABSTRACT

A system includes a processor that is configured to automatically confirm consultation hours of a pre-registered medical facility via a communication network when a notification is received from an educational institution indicating a child's poor physical condition, compare the obtained consultation hours with reservable time slots, automatically select an earliest reservable time slot within the consultation hours, and generate a prompt statement for making a reservation, receive voice data or text data from a user, analyze an emotion of the user by using a generative AI model, and generate a prompt statement for selecting an optimal medical facility according to the emotion, and generate a prompt statement for automatically settling a medical fee by cooperating with an electronic payment system after completion of the reservation.

### CROSS-REFERENCE TO RELATED APPLICATION

This application is based on and claims priority under 35 USC 119 from Japanese Patent Application No. 2025-045237 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In conventional medical reservation systems, when an educational institution such as a school or daycare contacts a parent regarding a child's sudden poor physical condition, the user is required to manually access a reservation site or make a phone call to confirm consultation hours, search for available time slots, and complete a reservation. This manual process forces the user to interrupt ongoing work, imposes a cognitive and temporal burden on the user, and may result in delays in securing an appropriate consultation time.

Furthermore, conventional systems typically do not take into account the user's emotional state when selecting a medical facility, and therefore cannot provide support that is sensitive to the user's anxiety, urgency, or preferences as reflected in emotion. In addition, conventional systems generally handle payment as a separate, subsequent operation that must be carried out manually after the medical consultation, which is inconvenient and may cause additional burden to the user. In view of these problems, there is a need for a system that, upon receiving a notification of a child's poor physical condition from an educational institution, can automatically confirm consultation hours of a pre-registered medical facility, automatically secure an earliest possible reservable time slot within those consultation hours, flexibly select an optimal medical facility in accordance with the user's emotional state by using a generative AI model, and automatically generate prompts for electronic settlement of the medical fee, all in a manner that allows the user to continue necessary work without interruption.

### SUMMARY

In order to solve the above-described problems, according to one aspect of the present invention, there is provided a system comprising a processor, wherein the processor is configured to automatically confirm consultation hours of a pre-registered medical facility via a communication network when a notification is received from an educational institution indicating a child's poor physical condition, compare the obtained consultation hours with reservable time slots, automatically select an earliest reservable time slot within the consultation hours, and generate a prompt statement for making a reservation. The processor is further configured to receive voice data or text data from a user, analyze an emotion of the user by using a generative AI model, and generate a prompt statement for selecting an optimal medical facility according to the emotion, thereby enabling selection of a medical facility in a manner responsive to the user's emotional state, such as anxiety or urgency. Moreover, the processor is configured to generate a prompt statement for automatically settling a medical fee by cooperating with an electronic payment system after completion of the reservation, so that the payment process can be executed seamlessly without additional manual steps by the user. In some embodiments, the processor is configured to use a background process that operates while the user performs necessary work in order to make the reservation, thereby enabling the user to continue work without interruption during the automatic reservation and payment preparation process. In other embodiments, the processor is configured to generate a prompt by using the generative AI model and obtain an emotion analysis result, in order to determine an emotional state by analyzing the voice data or the text data, thus providing a mechanism for dynamically adapting the reservation and facility selection behavior based on the user's emotions.

The term “processor” refers to one or more hardware processing units, such as a CPU, GPU, ASIC, FPGA, or a combination thereof, and may further include associated memory, that execute instructions to perform the functions described in the claims.

The term “communication network” refers to any wired or wireless network, including the Internet, a local area network, a wide area network, or a cellular network, that enables data communication between the system, an educational institution, a medical facility, and an electronic payment system.

The term “educational institution” refers to any organization responsible for the care or education of a child, including but not limited to a school, kindergarten, nursery school, daycare center, or after-school facility, that can issue a notification regarding a child's physical condition.

The term “pre-registered medical facility” refers to a clinic, hospital, or other healthcare institution whose identification information and related data have been registered in advance in association with a user in the system.

The term “consultation hours” refers to one or more time intervals during which a medical facility provides medical examinations or consultations and accepts patients for in-person or remote medical services.

The term “reservable time slots” refers to discrete time intervals within a given date during which the medical facility allows reservations to be made for consultations, and that can be obtained or confirmed by the system via the communication network.

The term “earliest reservable time slot” refers to a reservable time slot whose start time is earlier than the start times of other valid reservable time slots within the consultation hours for a specified date.

The term “prompt statement” refers to a piece of text, structured data, or equivalent representation generated by the processor for use as an input or instruction to another system or model, including but not limited to a generative AI model, a reservation system, or an electronic payment system.

The term “voice data” refers to digital audio data representing spoken utterances of a user, obtained by a microphone or other audio-capturing device, and suitable for processing by speech recognition or emotion analysis algorithms.

The term “text data” refers to digital textual information input by the user or derived from speech recognition of the user's voice, including messages, queries, or other linguistic content that can be analyzed for emotion.

The term “generative AI model” refers to a machine learning model, such as a large language model, multimodal model, or other generative model, that is trained to generate outputs including text, prompts, or intermediate representations based on input data such as voice data, text data, or context information.

The term “emotion” refers to an affective state of the user, such as anxiety, calmness, urgency, frustration, or relief, inferred from voice data or text data by the generative AI model or by associated emotion analysis components.

The term “optimal medical facility” refers to one medical facility selected by the processor as suitable for the user based on at least one criterion including the user's emotional state, facility availability, consultation hours, location, specialty, or past usage history.

The term “electronic payment system” refers to any system or service capable of processing digital financial transactions, including credit card payment gateways, electronic wallets, online banking systems, or other payment platforms with which the system can communicate via the communication network.

The term “background process” refers to a software process or thread executed by the processor without requiring active operation by the user and without interrupting foreground tasks being performed by the user on a terminal.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

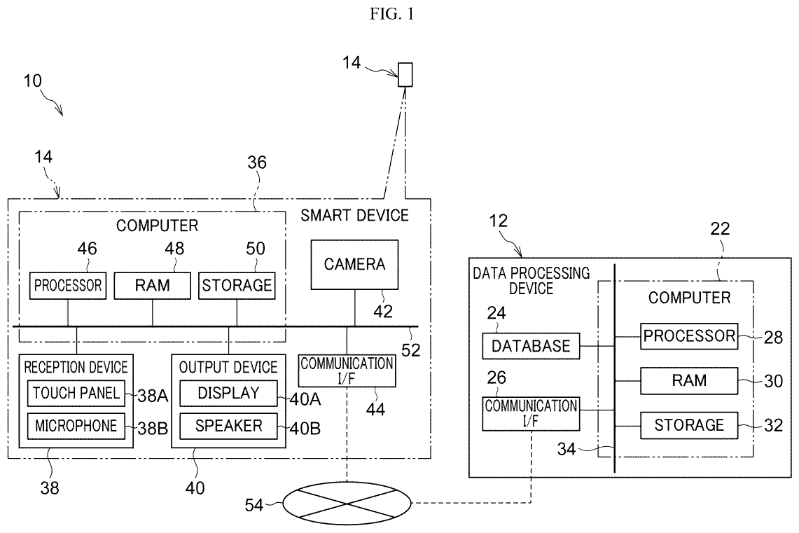

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

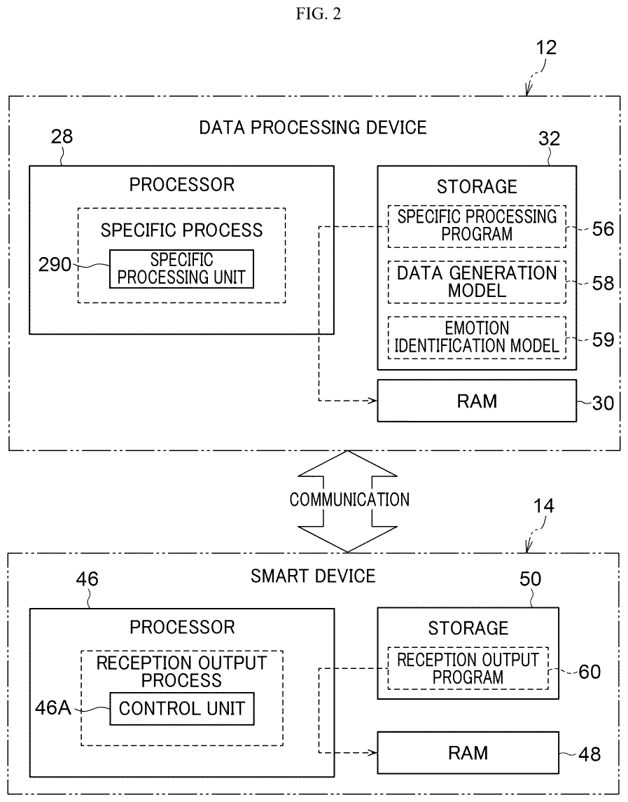

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60.

The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional appointment reservation systems and medical facility search systems typically require a user to manually look up facility information, compare available time slots, and interact with multiple heterogeneous reservation interfaces. Such systems are often implemented as straightforward business logic on top of general-purpose hardware, and they do not fully exploit contextual information such as real-time health status of a protected individual, current operating and reservable times of multiple medical service providers, user-specific preferences, or the user's emotional state. As a result, conventional systems incur high interaction cost, repeated network round-trips, and redundant computations on both client and server, which can increase processing latency, server load, and network traffic.

Moreover, when health-related notifications are initiated by an education-related institution, existing systems generally do not provide an integrated, end-to-end background workflow that automatically chains together condition information acquisition, facility operation information retrieval, optimal slot selection, reservation confirmation, and electronic settlement. Instead, these stages are handled by loosely coupled subsystems or by user-driven manual operations. This fragmented processing leads to non-deterministic processing paths, inefficient use of asynchronous communication resources, and increased risk of inconsistent or stale reservation data in storage devices.

Further, while generative AI models have become available as powerful tools for language understanding and generation, typical systems either use such models in isolation as conversational interfaces or apply fixed, heuristic-based emotion detection. They do not integrate generative AI models as first-class components in the core reservation and notification pipeline, nor do they systematically encode condition information, temporal constraints, historical reservation context, and user emotional state into well-structured prompt sentences. Consequently, existing systems fail to leverage generative AI models to dynamically adapt scheduling logic, data representation formats, and communication timing based on machine-interpretable context, which limits the ability to optimize resource utilization and user interaction flows at the system level.

Additionally, conventional client-server architectures often require a user to remain actively engaged with a foreground application to progress through each step of the reservation workflow. In such architectures, background processing capabilities are underutilized or applied in an ad hoc manner, causing unnecessary user wait time, wasted CPU cycles due to repeated polling, and inefficient scheduling of network requests. This not only degrades user experience but also impedes scalability and robustness when serving a large population of protected individuals and associated users.

Therefore, there is a need for a computer-implemented system and server architecture that improves the underlying computer technology by (i) orchestrating multi-stage reservation processing as coordinated background tasks, (ii) unifying and structuring heterogeneous context data into prompt sentences for a generative AI model, (iii) using outputs of the generative AI model to dynamically adjust evaluation rules and control flows within the reservation and notification pipeline, and (iv) reducing redundant computation and communication overhead while maintaining consistency and timeliness of reservation and settlement data across storage and external management apparatuses.

The specific processing by the specific processing unit 290 of the data processing device 12 in Example 1 is realized by the following means.

The present invention provides a server comprising a processor and one or more storage devices, the processor being configured to execute instructions that cause the server to receive, via a communication network, condition information regarding a protected individual from an education-related institution, transform the condition information into structured data, and store the structured data in the storage devices; to access attribute information regarding a plurality of medical service providers stored in the storage devices, and acquire, on the basis of the condition information and location information associated with the protected individual, operation information including treatment service hours and reservable time periods of the medical service providers; to perform, in the server, scoring-based evaluation processing that extracts available time periods within the treatment service hours from the reservable time periods and automatically selects an optimal reservation time period according to at least one evaluation rule; to generate reservation generation data including the selected optimal reservation time period and identification information of a medical service provider, and to execute, through an interactive communication interface with an external reservation management apparatus, a reservation confirmation process that transmits a reservation request based on the reservation generation data, receives reservation identification information and confirmation information, and stores the received information in the storage devices; to generate notification data including at least the reservation identification information and the confirmation information, and to provide the notification data to a portable information processing terminal of a user via at least one of a push-type notification channel, a short message channel, and an electronic mail channel; to acquire audio data or character data from the user in association with the condition information and the reservation generation data, and to construct and transmit, as a prompt sentence to a generative information processing model, an emotion analysis prompt sentence that encodes the audio data or the character data together with contextual information including at least a portion of the condition information, the treatment service hours, the reservable time periods, and past reservation history information, receive an emotion analysis result from the generative information processing model, and dynamically modify at least one of the evaluation rule for scoring the available time periods, a selection condition for the medical service providers, a representation format for the notification data, and an execution timing for a fee settlement process, on the basis of the emotion analysis result; to determine fee information related to provision of treatment service based on a result of the reservation confirmation process, construct a settlement processing prompt sentence including the fee information and the reservation identification information, and transmit the settlement processing prompt sentence to an external settlement management apparatus such that electronic fee settlement is performed in coordination with the external settlement management apparatus; to schedule and execute, as background processing, at least a portion of a condition information reception process, a medical service provider operation information acquisition process, the reservation confirmation process, a notification data generation and transmission process, and the fee settlement process while allowing a foreground application on the portable information processing terminal to execute other tasks without blocking; and to generate, using at least part of the condition information, the reservation generation data, the emotion analysis result, and information related to the fee settlement process as input, an explanation generation prompt sentence for the generative information processing model, submit the explanation generation prompt sentence to the generative information processing model, obtain natural-language explanation information from the generative information processing model, and embed the natural-language explanation information into the notification data to be delivered to the portable information processing terminal. This enables integrated, background-orchestrated reservation and settlement processing that reduces user interaction burden and network overhead, while improving computational efficiency and adaptability of the server by exploiting generative AI model outputs to control evaluation rules, data flows, and notification behavior in a context-aware manner.

The term “processor” refers to one or more hardware-implemented computation units, such as a central processing unit or a processing core, configured to execute machine-readable instructions to perform data processing operations of the system.

The term “storage device” refers to a hardware-based data holding component, such as a memory device or a non-volatile storage device, configured to store structured and unstructured digital information used by the system.

The term “communication network” refers to a wired or wireless data transmission infrastructure, such as a packet-switched network, over which messages, requests, and responses are exchanged between the server, external apparatuses, and terminals.

The term “education-related institution” refers to an organization responsible for providing educational or childcare services, such as a school or a childcare facility, that generates and transmits condition information regarding a protected individual.

The term “protected individual” refers to a person, such as a child or a dependent, for whom health-related condition information is managed and for whom medical service reservations are made by the system.

The term “condition information” refers to data describing a physical or mental state of a protected individual, including at least one of symptom content, severity level, time of occurrence, and current location context.

The term “structured data” refers to condition information or other information that has been transformed into a machine-parsable format, such as records, fields, or key-value pairs, suitable for storage in a database or similar data structure.

The term “attribute information” refers to descriptive data associated with a medical service provider, including at least one of facility type, specialty, geographic location, operational policy, and contact information.

The term “medical service provider” refers to an entity that offers medical examination, diagnosis, or treatment services, such as a clinic, a hospital, or a medical practice.

The term “operation information” refers to time-related and resource-related data for a medical service provider, including at least treatment service hours, reservable time periods, and optionally capacity or occupancy status.

The term “treatment service hours” refers to time intervals during which a medical service provider is scheduled to offer medical services and can legally or practically see patients.

The term “reservable time periods” refers to time intervals for which a reservation for medical services may be accepted by a medical service provider, including information indicating availability or unavailability of reservations.

The term “location information” refers to data representing a physical position associated with a protected individual or a medical service provider, including at least one of an address, geographic coordinates, or a region identifier.

The term “available time period” refers to a time interval that lies within treatment service hours of a medical service provider and that is not fully occupied according to reservable time period information.

The term “evaluation rule” refers to one or more criteria, conditions, or weighting schemes used by the processor to score, rank, or select time periods or medical service providers.

The term “scoring-based evaluation processing” refers to a computation that assigns numeric or ordinal scores to candidate time periods or medical service providers according to at least one evaluation rule, and uses the scores to select an optimal candidate.

The term “optimal reservation time period” refers to a specific available time period selected as most suitable among candidate time periods according to at least one evaluation rule and associated scoring results.

The term “reservation generation data” refers to a set of information used to create a reservation request, including at least the optimal reservation time period, identification information of a medical service provider, and information identifying a protected individual.

The term “external reservation management apparatus” refers to a remote system, such as a reservation server or a scheduling platform, that receives reservation requests via a communication interface and manages reservation records for one or more medical service providers.

The term “interactive communication interface” refers to an application-level protocol or endpoint, such as a request-response application programming interface, that allows the server and an external apparatus to exchange reservation-related messages.

The term “reservation request” refers to a message transmitted by the server to an external reservation management apparatus that requests creation, modification, or confirmation of a reservation for a protected individual.

The term “reservation identification information” refers to data that uniquely or semi-uniquely identifies a reservation, such as a reservation identifier or confirmation code, assigned by an external reservation management apparatus or by the server.

The term “confirmation information” refers to data returned from an external reservation management apparatus indicating the outcome of a reservation request, including at least one of success status, confirmed time, and any special instructions.

The term “notification data” refers to information prepared by the server for delivery to a terminal or user, including at least reservation identification information, confirmation information, and optionally natural-language explanations or additional instructions.

The term “portable information processing terminal” refers to a user-operated computing device, such as a smartphone or a tablet computer, that is capable of receiving notifications and displaying reservation-related information.

The term “push-type notification” refers to a communication mechanism in which a server-initiated message is delivered to a terminal through a push notification service without an explicit request from the terminal at the time of delivery.

The term “short message” refers to a text-only or text-centric communication, such as a short message service message or a similar limited-length data message, capable of conveying reservation-related information to a terminal.

The term “electronic mail” refers to a message transmitted using a mail transfer protocol over a communication network, including a subject, body, and optionally attachments, to convey reservation or settlement information.

The term “audio data” refers to digitized sound signals representing spoken utterances or other audio expressions of a user, which may be used for emotion analysis or context extraction.

The term “character data” refers to textual data composed of characters or symbols input by a user, such as written messages, which may be used for emotion analysis or context extraction.

The term “generative information processing model” refers to a computational model, such as a generative AI model or a large language model, configured to generate output data including natural-language text in response to input prompt sentences.

The term “prompt sentence” refers to a structured input text or sequence of tokens supplied to a generative information processing model in order to elicit a desired type of output, such as an emotion analysis result or a natural-language explanation.

The term “emotion analysis prompt sentence” refers to a prompt sentence constructed so as to cause a generative information processing model to output information indicative of an emotional state associated with input audio data, character data, or both.

The term “emotion analysis result” refers to output information from a generative information processing model indicating at least one aspect of a user's emotional state, such as stress level, urgency, or sentiment polarity.

The term “selection condition” refers to a rule, filter, or constraint used to determine which medical service providers or which time periods are eligible for consideration in a reservation process.

The term “representation format” refers to a structure or style in which data, particularly notification data, is expressed, including choices of wording, level of detail, layout, and language style.

The term “fee information” refers to data representing monetary amounts or billing parameters associated with provision of medical services, including at least a charge amount and optionally tax or discount information.

The term “fee settlement process” refers to a sequence of operations that determine payment amounts and trigger electronic transactions for collecting fees related to medical services.

The term “external settlement management apparatus” refers to a remote payment processing system, such as an electronic settlement platform or a financial service system, that executes payment transactions on the basis of settlement-related information.

The term “settlement processing prompt sentence” refers to a prompt sentence that encodes at least fee information and reservation identification information, and is constructed to cause a target system, including a generative information processing model or a settlement management apparatus, to initiate or control a fee settlement process.

The term “background processing” refers to execution of tasks or processes by the server or a terminal in a non-foreground state, such that user interaction with other applications or tasks continues without being blocked by the reservation-related processing.

The term “condition information reception process” refers to a sequence of operations by which the server receives condition information from an education-related institution, validates the information, and stores it as structured data.

The term “medical service provider operation information acquisition process” refers to a sequence of operations by which the server obtains operation information, including treatment service hours and reservable time periods, from local storage or from external systems.

The term “reservation confirmation process” refers to a sequence of operations by which the server uses reservation generation data to communicate with an external reservation management apparatus and acquires reservation identification information and confirmation information.

The term “notification data generation and transmission process” refers to a sequence of operations by which the server composes notification data, optionally including natural-language explanations, and transmits the notification data to a portable information processing terminal through one or more communication channels.

The term “explanation generation prompt sentence” refers to a prompt sentence constructed to cause a generative information processing model to output natural-language explanation information that describes at least part of the condition information, reservation status, or fee settlement process.

The term “natural-language explanation information” refers to text or speech content generated in a human language by a generative information processing model, intended to explain or summarize system status, reservations, or settlements to a user.

In one embodiment, a server, a plurality of terminals, and one or more external management apparatuses cooperate over a communication network to implement the claimed system. The server includes at least one processor, a main memory, a non-volatile storage device, and a network interface. The processor executes an operating system such as a general-purpose server operating system and middleware such as a web server framework and an application server framework. The storage device stores program modules, configuration data, and multiple databases used by the system.

The server implements an application layer including a condition information management module, a medical provider information management module, a scheduling and scoring module, a reservation interface module, a settlement interface module, a notification management module, and a generative AI interaction module. The server also implements background execution control logic that schedules these modules as asynchronous tasks. The server uses, for example, a relational database management system to store structured data such as health condition events, medical provider attributes, reservation records, and settlement records.

The server receives condition information regarding a protected individual from an education-related institution. The server uses the network interface and a communication protocol stack to terminate incoming data connections from an institution-side system, which may transmit condition information in a structured message format such as a key-value representation within a transport protocol payload. The server uses a parsing module to transform raw message content into a health event record data structure. The health event record includes fields representing, for example, an individual identifier, symptom category, measured temperature, observation timestamp, source institution identifier, and optional free-text notes.

The server stores each health event record in a health events table within the relational database. The server uses an index on at least the individual identifier and timestamp fields to permit efficient retrieval of recent events. The server associates the health event record with an individual profile record that contains location information, preference attributes, and historical reservation statistics. The server thereby maintains a structured, queryable representation of incoming condition information.

The server accesses attribute information regarding a plurality of medical service providers.

The server stores medical provider records in a provider table, with fields including provider identifier, facility type, specialty category, geographical coordinates, base treatment service hours, contact endpoints for reservation APIs, and flags indicating acceptance of automatic reservations. The server further stores reservable time periods either as periodic patterns in a schedule table or as explicit time slot entries in a slot table. The server may obtain updated reservable time periods by periodically querying external reservation management apparatuses and merging responses into the internal database.

The server computes operation information by combining base treatment service hours with current reservable time periods. The server represents treatment service hours as structured intervals, each interval defined by a day-of-week, a start time, and an end time. The server represents reservable time periods as discrete time slot objects including a start timestamp, an end timestamp, a capacity value, and a vacancy flag. The server uses a time-normalization algorithm to align time slot objects with treatment service intervals, removing any slots that extend outside allowed hours and splitting slots at interval boundaries when necessary. This normalization reduces later search complexity, because downstream modules can operate on a uniform set of candidate slots.

The server uses the scheduling and scoring module to select an optimal reservation time period. The server first filters candidate slots by applying location-based and time-based constraints. The server converts the geographical coordinates of the protected individual and each provider into a distance metric using, for example, a great-circle distance computation, and discards providers beyond a configurable radius. The server then eliminates any slots earlier than a minimal lead time from the current time and any slots on dates marked as unavailable for the individual.

The server calculates a numeric score for each remaining slot. The server uses an evaluation rule that may include weighted components such as proximity weight, earliest-time weight, provider preference weight, and historical satisfaction weight. The server represents the evaluation rule as a parameter vector stored in configuration data. The server computes each score by multiplying feature values derived from the slot and provider (for example, normalized distance, normalized lead time, binary preferred-provider indicator) by corresponding weights and summing the results. The server may include non-linear transformations such as exponential decay for lead time to prioritize earlier slots. The server then ranks the slots by score and designates the highest-scoring slot as the optimal reservation time period.

The server generates reservation generation data by combining the optimal slot information with identifying information for the selected provider and the protected individual. The server constructs a data structure containing the provider identifier, slot start and end timestamps, individual identifier, and a summary of relevant condition information (for example, primary symptom and urgency level). The server stores this reservation generation data in a pending reservation table.

The server communicates with an external reservation management apparatus via an interactive communication interface. The server uses the reservation interface module to construct a protocol-conformant reservation request message, mapping internal field names to the external apparatus schema. The server includes time slot identifiers or explicit timestamps, individual identification or anonymized tokens, and any metadata required by the provider. The server transmits the reservation request over a secure transport channel, receives a response containing reservation identification information and confirmation information, validates the consistency of the confirmed slot with the requested slot, and stores the returned identifiers in a reservations table. The server thereby realizes an end-to-end reservation confirmation process that is tightly synchronized with internal data structures.

The server prepares notification data for a portable information processing terminal operated by a user. The server collates reservation identification information, confirmation information, provider contact information, and a human-readable time representation. The server optionally augments this data with a natural-language explanation produced by a generative AI model as described below. The server formats the notification data according to the requirements of each delivery channel. For a push-type notification, the server constructs a data payload with a title, body text, and custom fields for deep-linking within a terminal application. For a short message, the server constructs a concise text string. For electronic mail, the server generates a subject line and a body including reservation summary and instructions.

The server manages notification delivery by using one or more external delivery services.

The server invokes a push notification service endpoint with the terminal's registration token and payload, invokes a short message gateway endpoint with the recipient telephone number and text, or submits an email to a mail transfer agent. The server tracks delivery status in a notification log table. The server can thus reduce repeated polling by the terminal and avoid unnecessary bandwidth consumption, because the notification path is server-initiated and event-driven.

The server acquires audio data or character data from the user and associates this data with the condition information and reservation generation data. In one embodiment, a terminal records the user's spoken comments about the situation, converts the speech to digital audio data, and transmits the audio data or transcribed text to the server. Alternatively, the user inputs character data through a text input interface, and the terminal transmits the textual content. The server stores these data in a user expression table with references to the corresponding health event and reservation context.

The server constructs an emotion analysis prompt sentence for a generative AI model. The server selects salient parts of the audio or character data, such as phrases indicating urgency or concern, and combines them with structured context, including condition information, treatment service hours, reservable time periods, and past reservation history. The server formats this information as a structured natural-language input that encodes roles and constraints, for example:

“Analyze the emotional state of the parent based on the following message and context. Message: ‘I am very worried because the fever went up quickly and I cannot leave work right now.’ Condition: child has fever of 38.8 degrees Celsius since 13:00. Available time slots: today 15:30, 16:00, 17:00 at nearby providers. Past reservations: the parent prefers not to wait long at the clinic. Output a summary of urgency and stress level, and a recommendation on whether to prioritize earliest possible time or less crowded provider.”

The server transmits this prompt sentence to a generative AI model hosted either as an external service or as a local model. In one embodiment, the generative AI model is implemented as a neural network architecture of the transformer type, with multiple self-attention layers, feed-forward layers, and learned token embeddings. The model parameters are trained on large corpora of conversational and domain-specific text by minimizing a next-token prediction loss function, such as cross-entropy between predicted token distributions and ground truth tokens. The training process updates weights using stochastic gradient descent with variants such as Adam optimization, with learning rate scheduling and regularization techniques such as dropout and weight decay. The server may adapt the model to the medical reservation domain via fine-tuning using supervised examples of emotional labels and recommendations. The model thereby encodes complex relationships between language patterns and emotional states in its weight matrices.

The server receives an emotion analysis result from the generative AI model, typically in the form of a structured text or key-value pairs embedded in the output text. The server parses this output to extract, for example, an urgency level, a stress level, and a recommendation to either strongly prioritize earliest time or to consider less crowded providers. The server does not simply replace human judgment; instead, the server uses this analysis as an additional machine-interpretable signal that modifies internal evaluation rules.

The server dynamically adjusts the evaluation rule and selection conditions on the basis of the emotion analysis result. For example, if the emotion analysis indicates high urgency and high stress, the server increases the weight associated with earliest-time preference and reduces the weight associated with travel distance, causing the scoring module to select a nearer-term time slot even if it requires longer travel. If the analysis indicates low urgency and a need for reduced waiting time, the server increases the weight for providers historically associated with shorter on-site waiting and shifts selection conditions to prefer such providers. The server updates parameters in the evaluation rule configuration and re-runs the scoring computation for candidate slots. This dynamic re-weighting provides a technical effect: the internal slot ranking is adaptively controlled by machine-derived signals, reducing the need for repeated manual changes by the user and decreasing the number of reservation attempts that must be canceled or rescheduled later.

The server generates an explanation generation prompt sentence for the generative AI model.

The server constructs a natural-language request that includes at least condition information, chosen reservation time, provider characteristics, and settlement status. An example prompt sentence is:

“Generate a concise explanation for a parent. The child has a fever and needs to see a doctor. The system has selected an appointment at a pediatric clinic at 15:30 today. The clinic is close to the nursery and currently has available slots. The parent is under high stress and cannot leave work immediately. Explain why this time and clinic were selected, and provide clear instructions on what the parent should do next.”

The server transmits this prompt to the generative AI model, obtains natural-language explanation information, and incorporates the explanation text into the notification data. The server thereby offloads complex natural-language generation to the model while maintaining strict control over the underlying scheduling and reservation logic.

The server determines fee information related to treatment service provision by referencing tariff tables and provider configuration data. The server associates each reservation with a predicted service code or fee category based on provider type and appointment type. The server calculates expected fee amounts, including taxes or surcharges if applicable, and constructs a settlement processing prompt sentence containing these amounts and reservation identification information. The settlement processing prompt sentence describes a payment instruction to an external settlement management apparatus. The server transmits this instruction through an authenticated channel and processes confirmation responses to mark the reservation as settled in an internal settlement table.

The server uses background processing to manage condition reception, provider information acquisition, reservation confirmation, notification generation, and fee settlement. The server schedules these tasks in an event-driven or queue-based execution system. When the server receives condition information, the server enqueues a job in a task queue. Worker processes running on the server consume these jobs and perform the described processing steps without requiring the user or the terminal to remain connected and idle. This architecture reduces latency by overlapping network calls, database operations, and AI model interactions, and it reduces resource contention by spreading workloads across processing cores. As a result, the server achieves higher throughput and lower average response time than a naive synchronous implementation that would block on each user interaction.

The terminal operates as a portable information processing device. The terminal includes a processor, memory, display, radio interface, and input devices. The terminal executes an application that registers the device with the server's notification subsystem, receives push-type notifications by a push service, and displays reservation and settlement information. The terminal may also present user interfaces for entering textual comments, recording audio, and selecting preferences. The terminal transmits such information to the server through secure network connections. The terminal thereby acts as an interface layer, while complex scheduling, scoring, AI interaction, and settlement processing occur on the server.

The user interacts with the terminal according to simple operations instead of managing low-level scheduling or contacting multiple providers. For example, when the user receives a notification stating that an appointment has been reserved at 15:30 at a specified pediatric provider, the user may view detailed explanations generated by the generative AI model, confirm that the proposed plan is acceptable, or initiate a change request. The user does not need to understand or configure the internal scoring rules; instead, the system adapts to context and emotional state by automatically tuning evaluation parameters within the server.

The described architecture yields several technical effects beyond mere automation of human tasks. The server's structured representation of condition information, provider attributes, and time slot data reduces memory usage and improves query efficiency due to indexed database storage and normalized data models. The scoring-based evaluation avoids exhaustive search over time periods and providers, because filtered and normalized candidate sets can be evaluated in linear time with respect to the number of slots. The adaptive adjustment of evaluation rules based on emotion analysis results reduces the number of unsuccessful reservation attempts and follow-up modifications, thereby lowering network traffic and processing overhead in both the server and external reservation systems. The background processing design decreases perceived latency at the terminal, as the server can complete reservation and settlement steps while the user continues other activities. Furthermore, by expressing complex context in prompt sentences for a generative AI model, the server obtains high-quality emotional and explanatory outputs that would be difficult to derive with simple rule-based systems, while still maintaining explicit, verifiable control over scheduling decisions.

In alternative embodiments, the server may host the generative AI model locally instead of invoking an external service. In such embodiments, the server loads model parameters into an accelerator-enabled computation environment, uses batched inference to process multiple prompt sentences in parallel, and applies quantization or pruning techniques to reduce inference latency and memory footprint. The server may further use curriculum learning or domain-adaptive fine-tuning to bias the model toward medical scheduling tasks, optimizing an objective function that combines language modeling loss with auxiliary classification loss for emotional labels. The server may also use data augmentation techniques, such as paraphrasing or back-translation, to produce additional training examples for rare emotional states, thereby improving robustness of the emotion analysis result and, consequently, the stability and accuracy of the dynamic evaluation rule adjustment.

In another variation, the server may use additional signals, such as measured historical waiting times at each provider, network quality metrics between the server and external reservation systems, or processor load statistics, as features in the scoring-based evaluation. By incorporating these technical state parameters into the scoring algorithm, the server can avoid overloading particular external systems, distribute reservation requests more evenly, and reduce the risk of timeouts or dropped connections. This embodiment provides a direct improvement in reliability and scalability of the underlying computer system.

In yet another embodiment, the server may deploy redundancy and replication mechanisms for key databases. The server may maintain replicas of the provider and reservation databases across multiple physical nodes and use transaction logs to ensure consistency. The scoring and reservation modules may then operate on local replicas, reducing network hops and improving query response times. The generative AI interaction module may also cache intermediate embeddings or analysis results for repeated patterns of condition information, further decreasing inference time and reducing computational load.

By tightly integrating structured data processing, adaptive scoring algorithms, neural network-based generative AI interactions, and asynchronous background scheduling across server, terminal, and external apparatuses, the system realizes a specific improvement in computer technology. The system reduces computational complexity of multi-provider reservation selection, improves accuracy and stability of scheduling decisions by incorporating machine-analyzed emotional and contextual factors, and decreases communication overhead via event-driven background workflows and push-based notifications, thereby enabling efficient and technically robust implementation of automatic medical reservation and settlement processing.

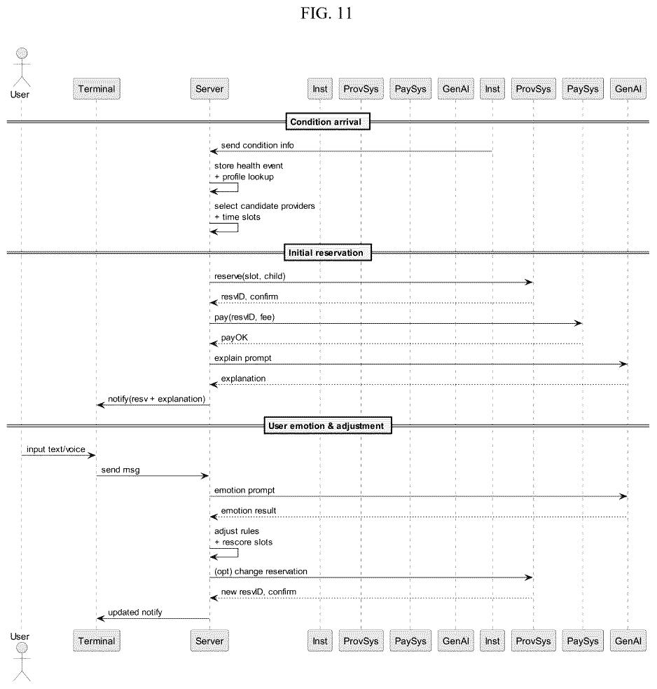

The following describes the processing flow using FIG. 11.

### Step 1:

Server receives and stores condition information from an education-related institution.

Server accepts, as input, a message transmitted from an institution system containing raw condition information for a protected individual, such as symptom description, temperature, observation time, and institution identifier. Server uses a communication interface (for example, an HTTPS endpoint) to receive the message and a parser module to convert the message into a structured health event record. Server performs data validation (checking required fields and formats), assigns a unique health event ID, and writes the record into a health events table in a database. Server outputs a stored health event record and its identifier for subsequent processing.

### Step 2:

Server retrieves individual profile and context associated with the health event.

Server uses, as input, the health event ID and associated protected individual ID stored in the health events table. Server queries an individual profiles table to obtain profile fields such as default residence address, usual institution address, historical provider preferences, and past reservation statistics. Server computes a reference location by selecting, for example, the institution address if the event source is a school or childcare facility. Server outputs a combined context object that bundles the health event record with the individual profile and reference location.

### Step 3:

Server selects candidate medical service providers based on location and specialty.

Server uses, as input, the combined context object including reference location and symptom category. Server queries a medical provider table to retrieve providers whose specialty matches the required domain (for example, pediatrics) and whose status flag indicates active participation in the automated reservation system. Server calculates a distance between the reference location and each provider's coordinates using a distance computation algorithm and filters out providers beyond a configured radius. Server outputs a list of candidate provider records, each including provider ID, specialty, coordinates, and base treatment service hours.

### Step 4:

Server acquires operation information and normalizes time slots.

Server uses, as input, the candidate provider records from Step 3. Server queries a treatment hours table to obtain base treatment service intervals for each provider and a time slot table or external reservation APIs to obtain current reservable time periods. Server merges base treatment service intervals with reservable slots by intersecting time intervals, splitting overlapping slots where necessary, and discarding any slots outside the providers' official hours. Server performs data operations to generate normalized time slot objects containing provider ID, start time, end time, and availability state. Server outputs a collection of normalized available time slots for all candidate providers.

### Step 5:

Server filters time slots using temporal and policy constraints.

Server uses, as input, the normalized available time slots and current system time. Server discards any time slots occurring before a minimum lead time threshold and any slots on dates that violate policy (for example, outside allowed days for the individual). Server applies additional filters based on configuration, such as excluding slots that conflict with known user constraints or institution closing times. Server outputs a reduced set of candidate time slots that satisfy basic temporal and policy constraints.

### Step 6:

Server computes scores for candidate time slots and selects an optimal reservation time.

Server uses, as input, the reduced set of candidate time slots, reference location, provider attributes, and evaluation rule parameters. Server calculates feature values for each slot, such as normalized distance, time-to-appointment, provider preference flag, and historical satisfaction indicator. Server multiplies these feature values by corresponding weights defined in the evaluation rule and sums the products to compute a numeric score for each slot. Server optionally applies non-linear functions such as exponential decay on time-to-appointment. Server sorts slots by score or identifies the maximum-scoring slot and outputs an optimal reservation time slot and its associated provider ID.

### Step 7:

Server generates reservation generation data and registers a pending reservation.

Server uses, as input, the optimal reservation time slot, provider ID, protected individual ID, and relevant condition summary fields. Server constructs reservation generation data including time slot, provider, individual, and context such as primary symptom and urgency level. Server inserts a record into a pending reservations table storing this data with a unique pending reservation ID. Server outputs the reservation generation data and the pending reservation ID for use in communicating with an external reservation system.

### Step 8:

Server communicates with an external reservation management apparatus to confirm the reservation.

Server uses, as input, the reservation generation data from Step 7 and configuration information for the provider's external reservation interface. Server maps internal fields into the external API schema, creates a reservation request message including time slot, individual information (or an anonymized token), and required metadata, and sends the message over a secure network connection. Server receives a response containing reservation identification information and confirmation information, checks consistency of the confirmed time with the requested time, and writes a new entry into a reservations table. Server also updates the pending reservations table to mark the corresponding record as confirmed. Server outputs a confirmed reservation record containing provider ID, time, reservation ID, and confirmation details.

### Step 9:

Server determines fee information and initiates an external settlement process.

Server uses, as input, the confirmed reservation record and provider-specific tariff information stored in a fee table. Server determines applicable fee categories based on provider type, appointment type, and policy, and calculates a fee amount, including any taxes or surcharges. Server constructs a settlement processing prompt sentence that encodes the calculated fee, reservation identification information, and basic payer information as a machine-interpretable instruction. Server sends the settlement processing prompt to an external settlement management apparatus and receives a settlement status response. Server stores the settlement status and transaction identifiers in a settlement records table. Server outputs an updated reservation record reflecting settlement state and amounts.

### Step 10:

Server acquires user audio or text data describing the situation or preferences.

Terminal presents, as input, user interface components such as a text input field and an audio recording button based on the confirmed reservation context. User inputs, as input, a spoken or written message expressing concerns, urgency, or preferences (for example, “I am very worried and I need the earliest possible appointment because my child's fever is going up”).

Terminal captures the audio waveform or text string, adds metadata such as timestamp and reservation ID, and transmits this data to the server via a secure connection. Server receives the audio or text data, stores it in a user expression table, and outputs an association between the expression record and the current reservation context.

### Step 11:

Server constructs an emotion analysis prompt sentence for a generative AI model.

Server uses, as input, the audio or text data, the associated health event record, available time slot list, and past reservation history. Server optionally converts audio data to text using a speech-to-text engine and extracts key phrases or tokens from the text. Server composes a structured natural-language prompt that includes: (i) the user's message, (ii) summary of the child's condition, (iii) a list of available time slots, and (iv) relevant history such as preferences or past waiting times. Server formats the prompt with explicit instructions to output urgency and stress levels and scheduling recommendations. Server outputs an emotion analysis prompt sentence suitable for submission to a generative AI model.

### Step 12:

Server submits the emotion analysis prompt sentence to a generative AI model and parses the result.

Server uses, as input, the emotion analysis prompt sentence generated in Step 11. Server sends the prompt to a generative AI model endpoint, for example a transformer-based language model, and receives a textual response. Server parses the response to extract structured values such as an urgency score, stress score, and a recommendation to either maximize appointment earliness or minimize on-site waiting. Server may use simple pattern matching or a secondary parser model to convert the free-form output into numeric or categorical fields. Server stores the emotion analysis result in an emotion analysis table linked to the reservation context and outputs the extracted urgency, stress, and recommendation values.

### Step 13:

Server dynamically adjusts evaluation rules and recalculates slot scores based on emotion analysis.

Server uses, as input, the emotion analysis result and the previously computed candidate time slots and scores. Server adjusts the evaluation rule parameters by, for example, increasing the weight of early-time preference when urgency is high, decreasing the weight of distance when stress is high, or emphasizing providers with historically shorter waiting times when stress is moderate but waiting tolerance is low. Server recomputes scores for candidate slots using the updated weight vector and, if necessary, selects a different optimal slot. Server outputs a revised optimal reservation time slot and provider ID if the ranking changes, or confirms the current choice if it remains optimal.

### Step 14:

Server generates an explanation generation prompt sentence to obtain a user-friendly explanation.

Server uses, as input, the final chosen reservation slot, provider attributes, condition information, and emotion analysis result. Server composes a natural-language prompt that specifies the context and instructs the generative AI model to generate an explanation suitable for a non-technical user. For example, server generates a prompt sentence of the form: “Explain to the parent why the system chose an appointment at 15:30 at a nearby pediatric clinic, considering that the child has a high fever and the parent is under high stress and cannot leave work immediately.” Server outputs the explanation generation prompt sentence ready to be submitted to the generative AI model.

### Step 15:

Server obtains natural-language explanation text and prepares notification data.

Server uses, as input, the explanation generation prompt sentence from Step 14. Server sends the prompt to the generative AI model and receives a natural-language explanation. Server combines this explanation with reservation identification information, confirmation information, provider address and contact data, and settlement status to form notification data. Server tailors the representation format by, for example, selecting a concise version for short messages and a more detailed version for email or in-app views. Server outputs fully assembled notification data objects for each intended delivery channel.

### Step 16:

Server delivers notification data to the terminal via push, short message, or email.

Server uses, as input, the notification data from Step 15 and user communication preferences stored in a notification settings table. Server calls external delivery services: for push notifications, server sends payloads to a push service with the terminal's registration token; for short messages, server sends text to an SMS gateway with the user's phone number; for electronic mail, server sends message content through a mail transfer service. Server records delivery attempts and statuses in a notification log. Server outputs delivery results indicating which channels succeeded and when, enabling later diagnostics or retries.

### Step 17:

Terminal receives and displays reservation and explanation information to the user.

Terminal uses, as input, notification messages delivered by push service, short message service, or mail client. Terminal parses payloads or message content to extract key fields such as clinic name, appointment time, reservation ID, and explanation text. Terminal displays this information on the screen, for example as a notification banner and a detailed view in an application. Terminal also provides interactive elements allowing the user to acknowledge the reservation, open a map, or initiate a call. Terminal outputs user interaction events, such as “viewed,” “acknowledged,” or “requested change,” which can be transmitted back to the server for further processing.

### Step 18:

User reviews the information and optionally provides feedback or change requests.

User uses, as input, the displayed reservation summary and explanation text. User reads the explanation, confirms whether the time and provider are acceptable, and may either accept the reservation implicitly by taking no action, or explicitly request changes. User can input additional comments or preferences through text or speech interfaces exposed by the terminal, such as “Please find a later slot after 17:00” or “I would prefer a clinic closer to home.” User thereby generates new character data or audio data that the terminal captures and sends to the server. User outputs human feedback that can trigger re-execution of some of the earlier steps, such as re-filtering and re-scoring, under updated constraints.

### Step 19:

Server executes background scheduling of tasks to optimize performance and responsiveness.

Server uses, as input, events such as receipt of condition information, external API responses, emotion analysis results, and user interactions. Server enqueues corresponding jobs into internal task queues and assigns them to worker processes for background execution. Server overlaps operations such as slot fetching, scoring, AI model requests, and settlement processing to avoid blocking user-dependent paths. Server monitors job queues and adjusts concurrency parameters to balance CPU, memory, and network usage. Server outputs processed results, including confirmed reservations, notifications, and settlements, without requiring synchronous blocking at the terminal, thereby reducing latency and improving scalability.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional computer-implemented scheduling and ordering systems, the processor typically executes fixed, rule-based workflows for booking services and placing orders. Such systems generally require explicit, structured input from a user and rely on static business logic hard-coded by developers. As a result, several technical problems arise.

First, when a notification relating to a child's health condition is received from an educational institution, existing systems lack an integrated mechanism to automatically interpret unstructured message content, correlate the content with heterogeneous time-based resource data such as consultation time information of medical facilities, and autonomously determine and execute an earliest feasible reservation. In many cases, the processor merely displays the notification to the user, leaving subsequent decision-making and data retrieval to manual operations. This leads to increased interaction rounds between the user terminal and the server, redundant database queries, and inefficient use of processing resources.

Second, existing architectures do not efficiently leverage generative AI models to convert diverse, unstructured inputs such as free-form natural-language notifications, user utterances, and calendar context into a unified, machine-interpretable representation that can drive downstream automated control flows. As a result, the processor must maintain complex, brittle parsing logic and multiple intermediate data schemas, which increases memory usage, processing latency, and error rates in rule evaluation and scheduling.

Third, known systems do not provide a cohesive framework for coordinating both medical reservation processes and food-and-beverage order processes under a single set of scheduling rules and automatic processing conditions. In conventional designs, medical booking modules and food ordering modules are implemented as separate subsystems, each with its own time comparison logic, external API integration layer, and state management. This duplication causes unnecessary CPU cycles, redundant network calls, and complicated error handling, and it impedes the scalability and maintainability of the overall system.

Fourth, emotion analysis of user voice or text inputs, when present, is typically implemented as an isolated feature. It is not tightly integrated as a first-class control signal in the reservation and ordering pipeline. Consequently, the processor cannot dynamically adjust facility selection or timing decisions based on the emotional state of the user, and cannot optimize system behavior for reduced user stress or urgency. This prevents the system from using emotion analysis to prioritize certain facilities or actions in a technically meaningful way.

Fifth, scheduling mechanisms in many existing systems rely on simple timers or external cron-like tools that trigger predefined jobs, without an internal representation of unified “scheduling rules and automatic processing conditions” that associate incoming notifications, external time tables (medical consultation times and food-and-beverage business hours), user schedule information, and outputs of a generative AI model. Without such an internal representation, the processor must repeatedly re-derive decision criteria at runtime, causing additional computation, inconsistent behavior, and difficulties in updating rules without redeploying application code.

Accordingly, there is a need for an improved computer-implemented system and server-side processing technique that: (i) automatically ingests and interprets unstructured notification data and user inputs; (ii) uses generative AI models through prompt sentences to produce uniform structured data that directly parameterizes reservation and ordering operations; (iii) unifies medical reservation and food-and-beverage ordering processes under shared scheduling rules and automatic processing conditions; and (iv) executes these processes as coordinated background tasks, thereby reducing user interaction burden, improving computational efficiency, and enhancing the technical robustness and flexibility of the server's control logic.

The specific processing by the specific processing unit 290 of the data processing device 12 in Application Example 1 is realized by the following means.

The present invention provides a server comprising a processor and a data storage device, the processor being configured to acquire, via a communication network, notification data from an education-related facility including state information relating to a child, to perform text analysis on the notification data to extract information relating to a health condition of the child, to generate a prompt sentence based on the extracted information, to input the prompt sentence into a generative AI model to obtain structured parameters for specifying a medical-related facility and a reservation condition, to acquire consultation time information of a plurality of medical-related facilities and business hour information of a plurality of food-and-beverage-related facilities from the data storage device, to compare a current time or a notification reception time with the consultation time information and the business hour information to automatically calculate an earliest reservable time slot or an orderable time slot, to generate and input further prompt sentences into the generative AI model to obtain reservation execution parameters, order execution parameters, and emotion analysis results from user voice or text data, and to perform cooperative control of a reservation process for the medical-related facility and an order process for the food-and-beverage-related facility in accordance with scheduling rules and automatic processing conditions stored in the data storage device. This enables the server to internally unify heterogeneous unstructured and structured inputs into a common, AI-generated control representation, to reduce the complexity and redundancy of rule-based code on the processor, to execute automated medical reservations and food-and-beverage orders as efficient background tasks responsive to real-time notifications and user state, and thereby to improve the technical performance, scalability, and adaptability of computer-based scheduling and ordering operations.

The term “processor” refers to a hardware computation unit or a combination of hardware and software resources, including one or more central processing units or processing cores, that executes machine-readable instructions to perform data processing, control logic, and communication functions of the system.

The term “data storage device” refers to a memory component or a storage subsystem, including volatile memory and non-volatile memory, configured to store programs, rules, user data, facility information, time schedules, and intermediate or final processing results used by the processor.

The term “communication network” refers to a wired or wireless data communication infrastructure, including local area networks, wide area networks, and public networks, that enables the exchange of digital information between the server, terminals, education-related facilities, medical-related facilities, food-and-beverage-related facilities, and external services.

The term “education-related facility” refers to an organization or institution that supervises or manages children in an educational environment, and that generates and transmits notification data relating to a child's status, including health-related conditions, to the server via the communication network.

The term “notification data” refers to electronic data, including text, symbols, and metadata, transmitted from an education-related facility and indicating a state of a child, such as a health condition, time of occurrence, or contextual information necessary for subsequent processing by the server.

The term “state information relating to a child” refers to information included in notification data that describes physical, emotional, or situational conditions of the child, including but not limited to indications of illness, symptoms, or abnormal behavior.

The term “text analysis” refers to a process executed by the processor that parses and interprets textual content in notification data or user inputs, including operations such as tokenization, syntactic parsing, keyword extraction, classification, and entity recognition.

The term “health condition of the child” refers to a state of the child relating to physical well-being, including conditions such as fever, pain, injury, or other symptoms or diagnoses relevant to determining a need for medical attention.

The term “medical-related facility” refers to an organization or service provider that offers medical, diagnostic, or therapeutic services, including but not limited to clinics, hospitals, and similar healthcare providers capable of accepting reservations or appointments.

The term “consultation time information” refers to time schedule data associated with a medical-related facility, including start times, end times, and availability intervals during which the facility can accept reservations or provide medical services.

The term “business hour information” refers to time schedule data associated with a food-and-beverage-related facility, including operating hours and intervals during which the facility is open and able to accept orders.

The term “food-and-beverage-related facility” refers to an organization or service provider that prepares, serves, or delivers meals or drinks, including restaurants, cafes, and similar establishments that support electronic ordering via the communication network.

The term “current time” refers to a time value obtained by the processor from a system clock or an equivalent timing source at the moment of processing, expressed in an absolute or standardized time format.

The term “notification reception time” refers to a time value indicating when the server receives specific notification data from an education-related facility, as recorded by the processor or associated communication components.

The term “earliest reservable time slot” refers to a time interval, determined by comparing current time or notification reception time with consultation time information, that is the first available interval within a consultation period in which a reservation can be accepted by a medical-related facility.

The term “orderable time slot” refers to a time interval, determined by comparing a desired order time with business hour information, that is within the operating period of a food-and-beverage-related facility and during which an order can be accepted or fulfilled.

The term “prompt sentence” refers to a textual input sequence generated or assembled by the processor, including instructions, context, and parameters, that is provided to a generative AI model to obtain a corresponding structured output or computation result.

The term “generative AI model” refers to a machine learning model, such as a language model, configured to generate or transform text or structured data in response to an input prompt, and to produce outputs including parameters, classifications, or structured representations for use by the processor.

The term “structured parameters” refers to machine-interpretable data elements, including key-value pairs, objects, or records, generated based on processing by the generative AI model, and used to control or configure reservation, ordering, or scheduling operations.

The term “reservation execution parameters” refers to structured parameters generated for controlling an automated reservation process, including information such as selected facility, date, time slot, user identifiers, and any additional options required by a medical-related facility's reservation interface.

The term “order execution parameters” refers to structured parameters generated for controlling an automated ordering process, including information such as facility identifiers, menu items, quantities, delivery or pickup details, and associated timing information.

The term “emotion analysis result” refers to information generated by processing user voice data or text data, indicating an inferred emotional state or attitude of the user, such as stress level, urgency, satisfaction, or other affective attributes.

The term “user voice data or text data” refers to digital representations of user communication, including audio signals converted into text and directly entered textual input, that are processed by the system to infer user intent, emotion, or preferences.

The term “facility selection parameters” refers to structured data used by the processor to select one facility from a plurality of candidate facilities, based on conditions such as consultation times, business hours, emotion analysis results, user preferences, or contextual constraints.

The term “reservation process” refers to a sequence of automated operations executed by the processor to establish a confirmed appointment with a medical-related facility, including forming request data, communicating with an external reservation interface, and storing resulting reservation information.

The term “order process” refers to a sequence of automated operations executed by the processor to place and confirm an order with a food-and-beverage-related facility, including constructing order data, communicating with an external ordering interface, and storing resulting order information.

The term “external settlement system” refers to a system or service separate from the server that provides electronic payment or settlement functions, and that is accessed by the processor to execute financial transactions relating to medical fees or order charges.

The term “electronic settlement processing parameters” refers to structured data used to control electronic payment operations, including identifiers of a transaction, payment method information, amounts, and any authentication tokens required by an external settlement system.

The term “menu information” refers to data relating to items offered by a food-and-beverage-related facility, including item identifiers, descriptions, categories, prices, and optional configurations such as size or additional ingredients.

The term “desired order time” refers to a time or time interval specified by a user, indicating when the user intends for an order to be placed, prepared, or delivered by a food-and-beverage-related facility.

The term “order content” refers to a specification of items to be ordered from a food-and-beverage-related facility, including types and quantities of products and any associated options or preferences.

The term “scheduling rules” refers to formalized conditions and procedures stored in the data storage device that define when and how the reservation process and the order process are to be initiated, modified, or canceled in response to inputs such as notification data, time information, and AI-generated outputs.

The term “automatic processing conditions” refers to criteria or thresholds stored in the data storage device that determine whether and under what circumstances the processor is permitted to automatically perform specific operations, including reservations, orders, and settlements, without additional explicit user input.

The term “schedule information of the user” refers to data representing planned activities or availability of the user, including calendar events, time constraints, and other temporal information relevant to scheduling operations.

The term “output results obtained from the generative AI model” refers to textual or structured data produced by the generative AI model in response to prompt sentences, including extracted facts, inferred conditions, recommended actions, or control parameters.

The term “cooperative control” refers to a control strategy by which the processor coordinates multiple processes, such as reservation and ordering processes, to operate in a mutually consistent and interdependent manner according to shared scheduling rules and automatic processing conditions.

The term “background task” refers to a process or thread executed by the processor under an operating system without requiring continuous direct interaction with a user, and typically triggered by timers, events, or scheduling rules.

The term “scheduler function” refers to logic or a software module that determines the timing and order of execution of tasks or processes, including initiating reservation and ordering operations periodically or in response to defined events.

The term “instruction sentence in natural language” refers to a text sequence expressed in a human language, provided by the user to indicate intent, preferences, or conditions, and used by the processor as part of a prompt sentence for the generative AI model.

The term “structured data” refers to information arranged in a predefined format, such as a table, record, or hierarchical object, that can be directly processed by the processor to make decisions regarding executability, timing, and selection of facilities for reservations or orders.

In an embodiment, a server, a terminal, and a user cooperate in a networked environment to implement the claimed system. The server includes at least one processor, a main memory, a non-volatile data storage device, and a network interface. The terminal includes a processor, a display, an input device, and a communication interface. The user operates the terminal to provide registration information, natural-language instructions, and confirmations.

The server executes an operating system such as a UNIX-like operating system or another multitasking operating system, and executes one or more application programs implemented in, for example, a server-side runtime environment such as a Java virtual machine, a Python interpreter, or a JavaScript runtime. The server uses a web server program such as a generic HTTP server or an application server for handling HTTPS requests and responses. The server uses a relational database management system such as a general-purpose SQL database, stored on the data storage device, to persist user profiles, facility information, scheduling rules, and outputs obtained by a generative AI model.

The server uses a generative AI model implemented as a large-scale neural network. In one embodiment, the generative AI model comprises a transformer-based language model that includes a plurality of layers of multi-head self-attention units and feed-forward networks, with layer normalization and residual connections. The generative AI model is trained on a large corpus of text data, and stores parameters representing word embeddings, positional encodings, attention weights, and layer-specific transformation matrices. The server accesses the generative AI model via an inference engine running on a computing resource such as a graphics processing unit or a specialized accelerator, either locally or via an external model-serving system communicating over the communication network.

In one embodiment, the server uses a natural-language processing pipeline implemented by libraries such as a general-purpose text-processing toolkit, for tokenization, part-of-speech tagging, and named-entity recognition. The server uses this pipeline for pre-processing notification data and user inputs before constructing a prompt sentence. The server stores intermediate representations of text as structured data objects including token arrays, part-of-speech tags, and entity labels in the main memory. The server processes these representations in order to extract features such as symptom keywords, time expressions, and named entities corresponding to facilities or persons.

The server acquires notification data from an education-related facility system via a secured API endpoint. The notification data includes at least a text message field and a timestamp field. The server parses the notification data into an internal data structure such as a record including a child identifier, a message string, a reception time, and metadata. The server then performs text analysis on the message string by converting it into a token sequence, mapping tokens to embedding vectors, and applying a classification model or rule set to detect whether the content expresses a health condition such as fever, pain, or injury.

The server stores, in the data storage device, consultation time information for each medical-related facility and business hour information for each food-and-beverage-related facility.

The consultation time information and business hour information are stored as normalized time intervals in a unified time zone, represented as structured records including facility identifiers, day-of-week fields, start time fields, and end time fields. The server maintains indexes on facility identifier and time fields in the database to accelerate range queries when determining an earliest reservable time slot or orderable time slot.

The server, when the notification data indicates a relevant health condition, constructs a prompt sentence that includes at least: (i) a summary of the extracted health condition; (ii) the child identifier; and (iii) a request to output structured reservation parameters. An example prompt sentence is:

“From the following child health notification: ‘The school reports that the child has had a fever of 38.5 degrees since this morning,’ extract the required fields to book a medical appointment. Output the child identifier, required medical department, urgency level, and a time window for the earliest possible visit.”

The server inputs this prompt sentence into the generative AI model. The generative AI model, using its transformer architecture, computes self-attention over the token sequence of the prompt sentence. The model generates context-aware hidden representations and then produces an output sequence that encodes the reservation execution parameters in a machine-interpretable format. The server then decodes the output sequence into structured parameters such as a selected medical department, a priority level, and a preferred time range.

The server computes an earliest reservable time slot by executing a time-comparison algorithm. The server retrieves all consultation intervals for candidate medical-related facilities from the database, and for each interval, compares the current time or notification reception time with the interval. The server uses arithmetic operations on time stamps and interval boundaries to detect available intervals in which the preferred time range can be satisfied. The server selects the earliest such interval according to a deterministic ordering rule, for example by sorting candidate intervals by start time and filtering by capacity or priority parameters. This deterministic algorithm reduces ambiguity and allows reproducible scheduling decisions.

The server uses another prompt sentence to drive the generative AI model to prepare request data for an external medical reservation interface. An example prompt sentence is:

“Generate the reservation parameters for an online medical appointment using the following data: facility A, child identifier X, department pediatrics, earliest available time between 15:00 and 16:00 today. Output the exact appointment time, reason for visit, and any required additional fields for a standard online reservation form.”

The server inputs this prompt sentence into the generative AI model and obtains structured reservation execution parameters including an exact time, a cause description, and a set of key-value pairs matching the external reservation interface requirements. The server then constructs a network request payload based on these parameters and transmits the payload via HTTPS to the medical-related facility's reservation API. The server parses the API response, stores the reservation confirmation in the database, and updates internal schedule information for the user.

The server acquires voice data or text data from the user via the terminal. In one embodiment, the terminal executes a speech-recognition module that converts spoken input into text, and then sends the text to the server. In another embodiment, the server itself receives the raw audio stream and applies an automatic speech-recognition model. The server constructs an emotion-analysis prompt sentence that includes the user's textual content and an instruction to classify emotional state. An example prompt sentence is:

“Analyze the emotional state of the following user message: ‘I am very worried because my child suddenly has a high fever.’ Classify the emotion into categories such as calm, stressed, urgent, or panicked, and provide a confidence score.”

The server inputs this prompt sentence into the generative AI model. The generative AI model uses its learned representations to output an emotion label and confidence measure.

The server uses these outputs as emotion analysis results and incorporates them into facility selection parameters. For example, when the emotion analysis result indicates a high level of urgency, the server biases its facility selection algorithm toward facilities with shorter estimated waiting times or 24-hour availability. The server implements this biasing by assigning weighted scores to candidate facilities and computing a ranking based on the combination of consultation time proximity, distance from the child's location, and urgency weight.

The server similarly manages automatic food-and-beverage ordering. The server stores menu information, including item identifiers, descriptions, and pricing for multiple food-and-beverage-related facilities. The server, based on user-specified rules, retrieves business hour information and checks whether a desired order time falls within an orderable time slot. The server then generates a prompt sentence that instructs the generative AI model to assemble order execution parameters. An example prompt sentence is:

“Using the following user preference: ‘On Friday at 18:00, order a large pepperoni pizza from my usual restaurant,’ generate the order details including item name, item size, quantity, requested delivery time, and any additional notes to be sent to the restaurant's online ordering system.”

The server uses the output of the generative AI model to construct a structured order including menu item identifiers, quantity, and requested delivery time. The server formats this order as a request message for the restaurant's online ordering API and sends the message via the communication network. The server receives a confirmation response, extracts an order identifier and estimated delivery time, and stores them in the database, thereby updating the user's schedule and order history.

The server stores, in the data storage device, scheduling rules and automatic processing conditions as structured records. Each rule includes fields such as trigger type (education-related notification, scheduled time, or user instruction), trigger condition (symptom type, day of week, or calendar event), applicable facility type, and priorities. The server also stores automatic processing conditions specifying whether reservations or orders may be automatically executed without additional user confirmation, and specifying thresholds for emotion levels or urgency levels. The server maintains these rules and conditions in normalized database tables with indexes on trigger types and conditions, enabling efficient rule retrieval when new data is received.

The server uses a scheduler function within the operating system or application framework to trigger background tasks. The scheduler function references the stored scheduling rules and automatic processing conditions and initiates reservation or ordering operations when relevant events occur, such as reception of notification data or arrival of a scheduled time.

The server, by using this scheduler function, reduces the need for continuous polling from the terminal and thereby reduces network traffic and processing load on both the server and terminal.

The server interacts with an external settlement system to perform electronic settlement of medical fees or order charges. The server generates a prompt sentence that includes reservation or order confirmation data, user payment preferences, and a request for transaction parameters compatible with the external settlement system. An example prompt sentence is:

“Prepare payment parameters for an electronic settlement of a medical fee of 80 units of currency, using the user's default payment method. Output transaction amount, currency, payment method type, and required authentication flags suitable for a standard payment gateway.”

The server obtains electronic settlement processing parameters from the generative AI model, formats them into an appropriate transaction request, and communicates with the external settlement system via a secure protocol. The server then records transaction identifiers and settlement outcomes in the database.

The generative AI model in this system is trained using supervised or semi-supervised learning on a training set of prompt sentences and desired structured outputs. The server or a training environment uses a loss function such as cross-entropy over output tokens or mean squared error over structured fields, and applies an optimization algorithm such as stochastic gradient descent with adaptive learning rates to update model weights. During training, the server or training environment applies regularization techniques such as dropout and data augmentation (for example, paraphrasing of prompt sentences) to improve generalization performance. As a result, the generative AI model learns to map heterogeneous input prompts to consistent, machine-usable structured representations.

The server improves computer technology by reducing the amount of hard-coded rule logic required to interpret unstructured messages and user inputs. By centralizing interpretation in the generative AI model and using prompt sentences, the server converts a wide variety of natural-language expressions into a unified internal representation. This unification reduces the number of conditional branches and parsing routines in the application code, thereby reducing code complexity and maintenance cost. The server, by using indexed time-interval data structures for consultation time information and business hour information, performs time comparisons with fewer database queries and reduced computational overhead, improving processing speed and scalability as the number of facilities increases.

The server reduces communication load between the terminal and external facilities by aggregating multiple interpretation and decision steps into a minimal number of API calls.

For example, the server uses a single prompt sentence to derive both reservation execution parameters and facility selection parameters, instead of requiring multiple interactions with different decision services. This design lowers latency and reduces the number of network round trips.

The server enhances accuracy and robustness of scheduling decisions. The generative AI model, by learning from a large dataset of examples, handles ambiguous or informal user expressions more accurately than conventional rule-based parsers. The server uses confidence scores from the generative AI model to determine when to request user confirmation versus when to proceed automatically. This controlled automation reduces erroneous reservations or orders and thereby improves overall system performance.

The server uses processing rules and algorithms that differ from manual human procedures.

For example, the server does not merely replicate a human's sequential decision flow; rather, the server performs parallel evaluation of multiple facility options, computes composite scores using facility selection parameters, and updates scheduling rules dynamically based on observed outcomes. The server uses emotion analysis not only for user convenience but as a technical input that adjusts internal algorithm weights and thresholds in real time, which a human operator cannot consistently perform across large numbers of cases.

In another embodiment, the server hosts the generative AI model locally on specialized hardware such as a dedicated accelerator card. In this case, the server loads the trained model parameters into device memory and performs inference with quantized weights or batched processing, thereby further reducing response time and computational cost. In another embodiment, the server offloads part of the natural-language pre-processing to the terminal, which executes a lightweight model to compress user input before transmission. This variation reduces uplink data volume and improves responsiveness under limited bandwidth conditions.

In still another embodiment, the server provides configuration options allowing the user to select different operating modes, such as a conservative mode where automatic actions are limited, or an aggressive mode where the server autonomously performs more operations.

The server stores these modes as additional fields in the scheduling rules and automatically adapts prompt sentence generation, thresholding, and facility selection accordingly.

Through these embodiments, the server, the terminal, and the user cooperate to implement the claimed system in a manner that is concretely tied to specific hardware and software structures, uses a defined generative AI model architecture and data structures, and achieves technical improvements in processing speed, accuracy, scalability, and resource utilization beyond mere automation of a human business workflow.

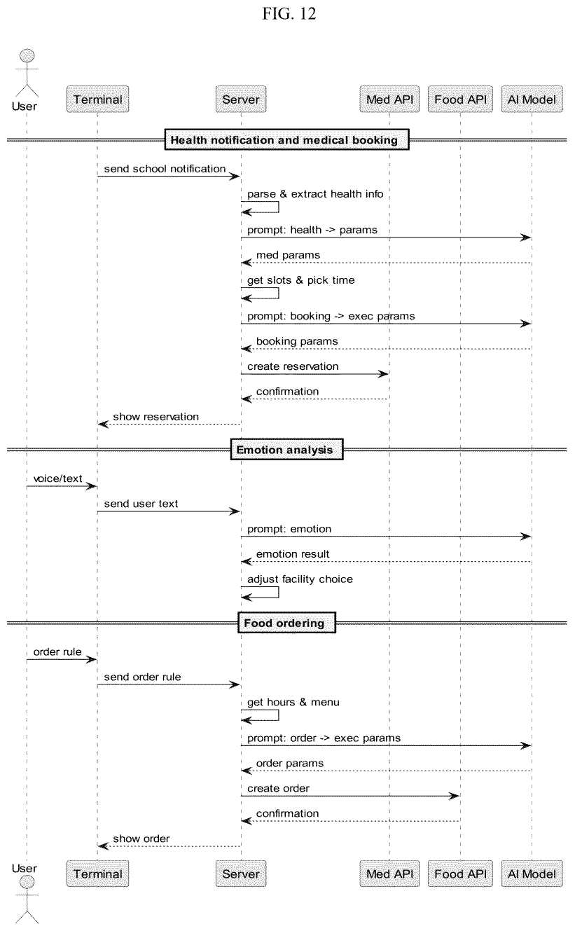

The following describes the processing flow using FIG. 12.

### Step 1:

Server receives and parses notification data from an education-related facility.

Server receives, as input, notification data over a communication network from an education-related facility system, the notification data including at least a message text and a timestamp.

Server uses an HTTP server module to accept the request and stores the raw payload in a temporary buffer. Server parses the payload into an internal record structure by mapping JSON or other serialized fields to in-memory variables such as child identifier, message string, and reception time. Server outputs a normalized notification record that can be used by subsequent modules.

### Step 2:

Server performs text analysis on the notification message to extract health-related information.

Server takes, as input, the message string from the normalized notification record of Step 1.

Server tokenizes the message string using a natural-language processing library, assigns part-of-speech tags, and applies a symptom classification model to detect references to health conditions such as fever, pain, or injury. Server computes feature vectors for each token and evaluates them against pre-trained symptom patterns to determine presence and severity of a health condition. Server outputs an extracted health-condition object that includes symptom type, estimated severity, and an onset time, if available.

### Step 3:

Server constructs a first prompt sentence for the generative AI model based on the extracted health information.

Server receives, as input, the extracted health-condition object and the child identifier from Step 1. Server formats a natural-language prompt sentence by inserting the symptom type, severity, and time information into a predefined template. For example, server generates a sentence such as: “From the following child health notification: ‘The child has a fever of 38.5 degrees since this morning,’ extract the required fields to book a medical appointment.

Output the child identifier, required medical department, urgency level, and a time window for the earliest possible visit.” Server performs string concatenation and escaping operations to ensure the prompt sentence is correctly formed. Server outputs the constructed prompt sentence as a text string.

### Step 4

Server sends the first prompt sentence to the generative AI model and obtains structured reservation parameters.

Server takes, as input, the prompt sentence from Step 3. Server packages the prompt sentence in a request format expected by the generative AI model inference engine and sends it via an internal API call or an external network call. Server receives, as output, a generated text sequence from the generative AI model, which represents structured reservation parameters.

Server parses this generated sequence using a predefined grammar or delimiter rules to extract fields such as medical department, urgency level, and preferred visit window. Server outputs a reservation-parameter object that is machine-interpretable.

### Step 5:

Server retrieves consultation time information for candidate medical-related facilities.

Server takes, as input, the medical department and urgency level from the reservation-parameter object of Step 4 and user registration information stored in a database. Server constructs and executes a database query to retrieve consultation time records for medical-related facilities associated with the user and matching the requested department. Server converts stored date and time values into a unified time zone and organizes them as interval objects in memory. Server outputs a list of consultation-time intervals annotated with facility identifiers.

### Step 6:

Server calculates an earliest reservable time slot based on consultation time information and current time.

Server takes, as input, the list of consultation-time intervals from Step 5 and a current time or notification reception time obtained from a system clock. Server iterates through the intervals, comparing the current time to each interval's start and end time using arithmetic on timestamps. Server selects only those intervals where the current time is earlier than or equal to the end of the interval and where capacity or urgency constraints are satisfied. Server sorts the qualifying intervals by start time and picks the earliest interval. Server outputs an earliest reservable time slot and a selected facility identifier.

### Step 7:

Server constructs a second prompt sentence to generate detailed reservation execution parameters.

Server receives, as input, the earliest reservable time slot and the selected facility identifier from Step 6, along with the child identifier and symptom summary. Server creates a natural-language prompt sentence describing the facility, the time slot, and required reservation details, such as: “Generate the reservation parameters for an online medical appointment using the following data: facility A, child identifier X, department pediatrics, earliest available time between 15:00 and 16:00 today. Output the exact appointment time, reason for visit, and any required additional fields for a standard online reservation form.” Server concatenates these details into a single text string. Server outputs the second prompt sentence as a text string.

### Step 8:

Server calls the generative AI model with the second prompt sentence and parses reservation execution parameters.

Server takes, as input, the second prompt sentence from Step 7. Server submits the prompt sentence to the generative AI model through an API, specifying inference parameters such as maximum output length and decoding strategy. Server receives, as output, a model-generated text that encodes reservation execution parameters, including an exact appointment time and field names and values required by an external reservation API. Server applies a parsing routine that splits the text into key-value pairs according to delimiters or markup conventions.

Server outputs a structured reservation-execution object suitable for direct API invocation.

### Step 9:

Server executes an online reservation process with a medical-related facility using the reservation execution parameters.

Server receives, as input, the reservation-execution object from Step 8. Server maps internal parameter names to the external reservation API's required fields and builds a network request payload, such as a JSON or form-encoded body. Server includes authentication tokens, user identifiers, and facility identifiers in the headers or request body. Server sends the request to the medical-related facility's reservation endpoint via HTTPS and waits for a response. Server parses the response to extract a reservation ID, confirmed appointment time, and any instructions. Server outputs a reservation-confirmation record and stores it in the database.

### Step 10:

Server acquires user voice or text data and constructs an emotion-analysis prompt sentence.

Terminal captures, as input, user voice data via a microphone or text data via a keyboard or touch input when the user interacts with the system. Terminal converts voice data to text using a speech-recognition component and sends the text to the server. Server receives the text, and constructs a prompt sentence that embeds the user's message and an instruction to classify emotional state, such as: “Analyze the emotional state of the following user message: ‘I am very worried because my child suddenly has a high fever.’ Classify the emotion into categories such as calm, stressed, urgent, or panicked, and provide a confidence score.”

Server outputs the emotion-analysis prompt sentence as a text string.

### Step 11:

Server obtains an emotion analysis result from the generative AI model and generates facility selection parameters.

Server takes, as input, the emotion-analysis prompt sentence from Step 10. Server sends this prompt sentence to the generative AI model and receives a generated text containing an emotion label and a confidence score. Server parses the text into a structured form, such as an emotion type and numerical confidence value. Server combines this emotion information with consultation time information and facility metadata (for example, distance and capacity) and applies a scoring function that multiplies or otherwise combines these values to generate facility selection parameters. Server outputs a set of weighted facility scores and a selected optimal facility identifier.

### Step 12:

Server constructs a payment prompt sentence and performs electronic settlement for a completed reservation.

Server receives, as input, a reservation-confirmation record from Step 9 and user payment preference data from the database. Server derives a transaction amount, currency, and payment method type from these inputs. Server builds a prompt sentence such as: “Prepare payment parameters for an electronic settlement of a medical fee of 80 units of currency, using the user's default payment method. Output transaction amount, currency, payment method type, and required authentication flags suitable for a standard payment gateway.”

Server sends this prompt sentence to the generative AI model and receives structured electronic settlement processing parameters. Server uses these parameters to construct a request to an external settlement system via a secure payment API, receives a transaction result, and outputs a settlement-confirmation record stored in the database.

### Step 13:

Server retrieves business hour and menu information for food-and-beverage-related facilities.

Server takes, as input, user registration information indicating preferred food-and-beverage-related facilities and any scheduling rules for ordering. Server queries the database to retrieve business hour information and menu information for these facilities. Server normalizes time information into a unified time zone and stores menu items as structured records with identifiers and attributes. Server outputs a collection of facility business-hour records and menu records available for order planning.

### Step 14:

Server checks orderability at a desired order time and constructs an order prompt sentence.

Server receives, as input, a desired order time and order content defined by the user or by previously stored rules. Server compares the desired order time with the business-hour records from Step 13 by performing interval membership checks for each facility. Server determines whether the desired time falls within an orderable time slot and, if necessary, adjusts to the closest valid time within a specified tolerance. Server then constructs a prompt sentence such as: “Using the following user preference: ‘On Friday at 18:00, order a large pepperoni pizza from my usual restaurant,’ generate the order details including item name, item size, quantity, requested delivery time, and any additional notes to be sent to the restaurant's online ordering system.” Server outputs the order prompt sentence as a text string.

### Step 15:

Server calls the generative AI model with the order prompt sentence and creates order execution parameters.

Server takes, as input, the order prompt sentence from Step 14. Server sends this prompt sentence to the generative AI model and receives a generated text that encodes detailed order information. Server parses the generated text into structured order execution parameters, including facility identifier, item name, size, quantity, and requested delivery time. Server maps item names to menu identifiers using the menu records retrieved in Step 13, and validates that the requested items are available. Server outputs a finalized order-execution object.

### Step 16:

Server executes an online order process and updates user schedule and history.

Server receives, as input, the order-execution object from Step 15. Server formats an HTTPS request payload for the selected food-and-beverage-related facility's ordering API, including order items, delivery address, contact information, and payment method references. Server sends the request and waits for an order confirmation response. Server parses the response to extract an order ID, estimated delivery time, and total cost, and stores these values in the database as an order record. Server updates the user's schedule information with the expected delivery time and outputs an updated schedule summary for retrieval by the terminal.

### Step 17:

Terminal displays reservation and order status, and user confirms or adjusts settings.

Terminal takes, as input, status information retrieved from the server via periodic or on-demand HTTPS requests. Terminal renders reservation details, order details, and upcoming events on a user interface. User reviews this information and may modify preferences or cancel operations. Terminal sends user modification commands to the server, such as cancel requests or rule updates. Server processes these commands by updating database records and, if necessary, calling external cancellation APIs, and then outputs updated status information to the terminal.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional appointment management systems for medical institutions typically require a human user to manually read notifications, search for appropriate medical facilities, check consultation schedules, and complete reservations and payments through multiple user interface operations. In environments where a guardian must respond to sudden notifications from an educational institution regarding a child's health condition, such manual workflows interrupt ongoing work, increase cognitive load, and introduce delays and human errors in selecting an appropriate facility and time slot. Furthermore, existing systems generally treat incoming messages as unstructured text, relying on simple keyword rules, and do not robustly exploit advanced machine-learning models to extract clinically relevant attributes, such as urgency, from heterogeneous notifications.

In addition, known systems often separate natural language understanding, scheduling logic, and transaction execution into loosely coupled or manually orchestrated steps. As a result, the systems lack an integrated control flow tying together: (i) automated extraction of child, symptom, and urgency attributes from institution notifications; (ii) automated discovery, filtering, and ranking of candidate medical facilities and time slots according to guardian constraints and urgency; and (iii) automatic execution of reservation and payment transactions. This fragmented architecture limits the technical capability of the system to process large volumes of heterogeneous notifications in real time and to operate reliably in the background without intensive user interaction.

Moreover, existing uses of generative AI models in consumer applications are typically confined to generating free-form text responses and are not designed as part of a deterministic, auditable pipeline that controls concrete data operations. In particular, prior systems do not provide a structured mechanism to generate and manage machine-readable prompt sentences that define the semantics of reservation requests, emotion analysis, and payment requests, and then use the generative AI model outputs as structured data within a transactional backend. This lack of a controlled prompt and audit framework makes it difficult to assure reliability, traceability, and security in mission-critical operations such as medical reservations and electronic payments.

A further technical issue arises in how user state, including emotional state, is incorporated into system decisions. Conventional appointment systems ignore the guardian's emotional state or, at best, log free-text feedback that is not computationally integrated into scheduling logic. As a result, these systems cannot dynamically adjust evaluation functions or selection criteria for time slots and facilities based on the guardian's stress level or expressed preferences as inferred from voice or text input. This limits the adaptability of the system and fails to leverage modern AI capabilities for user-centric decision support.

Accordingly, there is a need for an improved computer-implemented system that: (i) automatically normalizes and structures incoming notification data from educational institutions; (ii) uses generative AI models under explicit prompt control to extract semantic attributes, determine emotional state, and generate transaction-ready request data; (iii) integrates external reservation and payment interfaces into a single, auditable control flow; and (iv) runs these processes as background operations on a communication network, thereby reducing user burden, improving reliability and traceability, and enhancing the technical performance of appointment scheduling and payment processing in distributed computing environments.

The specific processing by the specific processing unit 290 of the data processing device 12 in Example 2 is realized by the following means.

The present invention provides a server comprising a processor configured to receive notification information from an educational institution via a communication network, normalize the notification information, and store the normalized notification information as internal data in a storage device; to extract, from the notification information, a child attribute, a symptom attribute, and an urgency attribute by performing rule-based analysis processing and natural language analysis processing using a generative AI model, and to generate structured data including the child attribute, the symptom attribute, and the urgency attribute; to associate the child attribute included in the structured data with child information and guardian information stored in a user information storage device, and to identify a guardian terminal and a communication route; to select, based on the symptom attribute and the urgency attribute included in the structured data and on medical facility information stored in a facility information storage device, one or more medical facility candidates in consideration of a specialty attribute, a location attribute, and a priority attribute; to acquire, for each of the medical facility candidates, consultation time information and reservable time information via an external reservation-information-providing interface, and to generate time-slot information normalized into a standard format; to extract, from the time-slot information, reservable time slots within consultation hours, based on time-constraint information and position information included in the guardian information, to rank a plurality of candidate time slots by using an evaluation function that considers at least the urgency attribute and travel time, and to automatically select an optimal reservation candidate time slot; to generate a prompt sentence defining contents of reservation request data to be transmitted to a reservation-information-providing interface of a medical facility, to cause the generative AI model to generate the reservation request data on the basis of the prompt sentence, to transmit the reservation request data to the reservation-information-providing interface, and to execute a reservation process; to store reservation identification information and consultation date-and-time information acquired as a result of execution of the reservation process in association with the structured data in a transaction information storage device, to generate a notification message including reservation results and consultation guidance for the guardian, and to transmit the notification message to the guardian terminal via an electronic mail transmission apparatus or a notification delivery apparatus; to generate a prompt sentence for automatic payment of a medical fee based on the result of the reservation process and medical fee information, to cause the generative AI model to generate payment request data on the basis of the prompt sentence, to transmit the payment request data to an electronic payment processing apparatus, and to execute a payment process; and to generate audit information in which a series of processing contents, transmission and reception contents with external interfaces, and input and output contents of the generative AI model are associated with one another, and to store the audit information in an audit information storage device. This enables an integrated, computer-implemented workflow in which heterogeneous notification data are converted into structured attributes, external reservation and payment services are orchestrated under explicit prompt control of a generative AI model, background execution is provided without continuous user interaction, and end-to-end transaction and AI behavior are recorded in an auditable form, thereby improving the technical performance, reliability, and usability of medical appointment and payment processing in distributed information processing environments.

The term “processor” refers to a hardware or virtual computation unit, such as a central processing unit or a processing core in a cloud computing environment, that executes program instructions to perform data processing, control, and communication functions of the system.

The term “communication network” refers to a wired or wireless data communication infrastructure, including at least one of a local area network, a wide area network, and the Internet, through which digital messages, requests, and responses are transmitted between the server, external services, and user terminals.

The term “notification information” refers to electronically transmitted data including at least a message body and associated metadata indicating a child-related event, such as a health condition report, provided from an educational institution via the communication network.

The term “educational institution” refers to an organization that provides childcare or education services, such as a school, a kindergarten, or a daycare facility, and that is capable of transmitting electronic notifications concerning a child.

The term “normalize” refers to processing raw digital data to convert it into a standardized internal format, including at least unifying character encoding, removing unsupported control information, and structuring metadata so that downstream components can systematically interpret the data.

The term “internal data” refers to a representation of received or generated information that has been transformed into a consistent, system-specific format and stored in a storage device for subsequent processing.

The term “storage device” refers to a hardware or virtual storage component, including at least one of a magnetic storage unit, a solid-state storage unit, or a network-accessible storage service, that records internal data, structured data, transaction data, or audit data.

The term “child attribute” refers to structured information identifying a child associated with a notification, including at least a name, and optionally including additional identifiers such as grade, class, or registration identifiers.

The term “symptom attribute” refers to structured information representing one or more health-related conditions reported for a child, such as fever, pain, or behavioral changes, extracted from notification information in a machine-readable format.

The term “urgency attribute” refers to a structured indicator of priority or criticality of a child's condition, such as a categorical level or a score, derived from semantic analysis of the notification information.

The term “rule-based analysis processing” refers to deterministic text or data processing carried out according to predefined rules, patterns, or algorithms, such as regular expressions or dictionaries, without using machine-learning-based inference.

The term “natural language analysis processing” refers to computational processing of human language text, including at least tokenization, parsing, classification, or entity extraction, to obtain structured semantic information from unstructured text.

The term “generative AI model” refers to a machine-learning model that generates output data, such as text or structured data, in response to input data and instructions, and that is trained on large amounts of data to perform natural language understanding and generation.

The term “structured data” refers to data organized into predefined fields or formats, such as key-value pairs or records, that explicitly represent attributes including at least child attributes, symptom attributes, and urgency attributes.

The term “user information storage device” refers to a storage device that holds records relating to children, guardians, and associated contact and preference information, which can be referenced to associate notification information with specific users.

The term “child information” refers to data stored in the user information storage device describing a child, including at least an identifier and optional demographic or enrollment details.

The term “guardian information” refers to data stored in the user information storage device describing a guardian of a child, including at least contact information, preference settings, time-constraint information, and location information.

The term “guardian terminal” refers to an electronic user device associated with a guardian, such as a mobile terminal, a tablet terminal, or a personal computer, capable of receiving notifications and presenting information to the guardian.

The term “communication route” refers to an electronic communication channel, such as an electronic mail address, a messaging endpoint, or a push-notification token, through which messages to a guardian terminal are delivered.

The term “facility information storage device” refers to a storage device that holds medical facility information including at least facility identifiers, specialties, locations, and scheduling-related attributes used for candidate selection.

The term “medical facility information” refers to data describing a healthcare-providing organization, including at least a specialty attribute, a location attribute, consultation hours, and reservation interface parameters.

The term “medical facility candidate” refers to a medical facility selected as a potential treatment destination for a child, based on medical facility information and attributes derived from structured data.

The term “specialty attribute” refers to an indicator representing a medical domain or department of a facility, such as pediatrics or internal medicine, used to align facilities with symptom and child attributes.

The term “location attribute” refers to data that indicate the geographical position of a facility or a user, such as coordinates, addresses, or region identifiers, used to evaluate distance and accessibility.

The term “priority attribute” refers to data that indicate a preference or importance ranking of medical facilities, based on criteria such as past usage, guardian preferences, or system-defined weights.

The term “external reservation-information-providing interface” refers to a programmatic interface, such as a network-accessible application programming interface, provided by a reservation-information-providing server or a medical facility system for obtaining or submitting reservation-related data.

The term “reservation-information-providing server” refers to an external server that manages or intermediates access to reservation-related data of one or more medical facilities and provides such data via an external reservation-information-providing interface.

The term “consultation time information” refers to data specifying time periods when a medical facility is open and able to provide consultations.

The term “reservable time information” refers to data specifying discrete time periods within consultation time information that are available for new reservations.

The term “time-slot information” refers to normalized representations of time intervals or time points that can be used to schedule consultations, including associated metadata such as facility identifiers and availability states.

The term “time-constraint information” refers to data specifying temporal limitations or preferences of a guardian, such as earliest permissible start time or latest permissible end time for appointments.

The term “position information” refers to data indicating the physical location of a guardian or child, or a reference location, used in calculating travel time or distance to a facility.

The term “evaluation function” refers to a computational function or algorithm that assigns scores or rankings to candidate time slots or facilities based on one or more attributes including at least urgency and travel time.

The term “reservation candidate time slot” refers to a time slot that satisfies basic constraints, has been evaluated by the evaluation function, and is considered as a possible target for an appointment.

The term “optimal reservation candidate time slot” refers to a reservation candidate time slot that is selected by the system as preferable over other candidates according to the evaluation function and constraints.

The term “prompt sentence” refers to a machine-readable instruction or query text configured to control a generative AI model, specifying the desired structure, content, or transformation of the model's output.

The term “reservation request data” refers to structured digital data containing information required by a medical facility or reservation-information-providing interface to register a reservation, including at least facility identification, time-slot information, and child-related information.

The term “reservation process” refers to a sequence of operations by which reservation request data are transmitted to an external reservation-information-providing interface and a resulting reservation is created, modified, or confirmed.

The term “transaction information storage device” refers to a storage device that records data relating to reservations, payments, and associated structured data for later retrieval and auditing.

The term “reservation identification information” refers to data that uniquely identify a reservation, such as a reservation number or code provided by a reservation-information-providing server or medical facility.

The term “consultation date-and-time information” refers to data specifying the date and time at which a consultation has been scheduled as part of a reservation.

The term “notification message” refers to electronically generated content that conveys information about reservation results and consultation guidance to a guardian, formatted for delivery through a communication route.

The term “electronic mail transmission apparatus” refers to a hardware or software component configured to send electronic mail messages via a mail protocol through a communication network.

The term “notification delivery apparatus” refers to a hardware or software component configured to send notifications, such as push notifications or messages, to user devices through a communication network.

The term “medical fee information” refers to data specifying expected or actual charges for a medical service associated with a reservation.

The term “payment request data” refers to structured data that specify information required by an electronic payment processing apparatus to execute a payment transaction, including at least an amount, a payee identifier, and a payment method.

The term “electronic payment processing apparatus” refers to an external system configured to process electronic payment transactions based on payment request data received via a communication network.

The term “payment process” refers to a sequence of operations for transmitting payment request data to an electronic payment processing apparatus, receiving a result of payment execution, and recording the result.

The term “audit information” refers to data that record a trace of processing steps, exchanged messages, and generative AI model inputs and outputs, in a manner that links them for later inspection of system behavior.

The term “audit information storage device” refers to a storage device configured to persistently store audit information for compliance, debugging, or analysis.

The term “background process” refers to a process executed by the processor in a non-interactive mode without requiring continuous real-time input from a user terminal, running on the communication network to complete reservations or payments.

In one embodiment, a server implements the claimed system as a network-connected computing apparatus including at least one processor, a main memory, a nonvolatile storage device, and a network interface. The server connects to a communication network such as the Internet and communicates with external systems including an educational-institution system, a reservation-information-providing server of a medical facility, an electronic payment processing apparatus, and guardian terminals. The server executes an operating system, such as a UNIX-compatible operating system, and an application stack implemented, for example, in a high-level language runtime. The storage device of the server holds program modules implementing the functions described below, as well as databases for user information, facility information, transaction information, and audit information.

The server uses a relational database management system, such as a general-purpose database engine, to manage multiple logical tables. The server prepares at least a “messages” table storing normalized notification information, a “children” table storing child information, a “guardians” table storing guardian information, a “facilities” table storing medical facility information, a “reservations” table storing reservation-related transaction information, and an “audit_logs” table storing audit information. Each table uses primary keys and foreign keys to maintain referential integrity. For example, the server associates entries of the “messages” table with entries of the “children” table by a child identifier and associates entries of the “children” table with entries of the “guardians” table by a guardian identifier.

The server receives notification information regarding a child from an educational institution via the communication network. The server exposes a programmatic endpoint, such as a Hypertext Transfer Protocol Secure (HTTPS) endpoint, and the educational institution transmits notification information via an electronic messaging service or a webhook mechanism. The server validates authentication headers and digital signatures to ensure message integrity and origin. The server then normalizes the incoming notification information by converting character encoding to a unified format, such as UTF-8, stripping markup tags and unsupported control characters, splitting message headers and body, and assigning a unique internal message identifier. The server stores the normalized message and associated metadata in the “messages” table. This normalization and structured storage allow subsequent modules to access uniform data structures, which improves data management consistency and reduces parsing errors compared to ad hoc text handling.

The server extracts child attributes, symptom attributes, and urgency attributes from the normalized notification information using a hybrid analysis engine. For deterministic components, the server executes rule-based analysis processing implemented with regular expression patterns, dictionary lookups, and time-expression parsers. For example, the server maintains a list of temperature patterns, symptom keywords, and grade indicators, and the server scans the message body to extract candidate temperature values, candidate child names, and expressions indicating temporal context. This rule-based processing rapidly narrows the search space and removes noise, which reduces the input complexity for subsequent machine-learning processing and thereby reduces computational load.

The server then applies natural language analysis processing using a generative AI model. In one embodiment, the generative AI model is a transformer-based neural network model trained for sequence-to-sequence text understanding and generation. The model includes an encoder-decoder architecture with multiple self-attention layers, positional encoding, and feedforward layers. The server stores model parameters as weight matrices in the storage device and loads them into memory for inference. The server configures the model with hyperparameters such as number of layers, hidden dimension size, attention head count, and tokenization vocabulary. The server tokenizes the normalized message text and a corresponding prompt sentence into subword tokens and feeds the token sequence to the generative AI model.

The server uses a prompt sentence to instruct the generative AI model to output structured semantic information. For example, the server may use a prompt sentence of the form: “Analyze the following message from a school or daycare and extract (1) the child's full name, (2) a list of short symptom phrases, (3) the child's body temperature in degrees Celsius if available, (4) an urgency level chosen from low, medium, high, and (5) a one-sentence summary for internal use. Respond in a concise form that clearly labels each item. Message: ‘Taro Yamada has complained of a headache and a 38.5° C. fever since this morning. He is resting in the nurse's office.’”

The server concatenates this prompt sentence and the normalized message body and passes the concatenated text to the generative AI model. The model computes attention scores and hidden representations at each layer according to the transformer architecture and generates output tokens corresponding to extracted attributes and summary text. The server post-processes the generated tokens to identify key segments associated with each requested item and constructs structured data containing the child attribute, symptom attribute, and urgency attribute. By using this explicit prompt sentence combined with the deterministic extraction post-processing, the server transforms generic neural network output into a predictable, machine-usable representation, which improves reliability and reduces the ambiguity often associated with free-form natural language generation.

The server associates the child attribute included in the structured data with existing child information stored in the “children” table. The server executes a matching algorithm that compares the extracted child name, grade, and institution identifier with database records. In one variation, the server computes similarity scores between the extracted name string and registered names using normalized string distance measures. The server selects a child record whose similarity score exceeds a threshold. The server then retrieves the guardian information corresponding to the matched child from the “guardians” table, including guardian contact channels, time-constraint information, and position information representing a home or workplace location.

The server identifies a guardian terminal and communication route based on the guardian information. For example, the server may select a push-notification channel for urgent cases and an electronic mail channel for non-urgent cases. The server stores the communication route in association with the message identifier and child identifier. These associations form explicit keys for subsequent notification processing, which supports deterministic routing and auditability.

The server selects one or more medical facility candidates using the symptom and urgency attributes. The server retrieves medical facility information from the “facilities” table, including facility identifiers, specialty attributes, location attributes, consultation hours, and priority attributes. The server filters facilities by specialty attribute, such as pediatric specialties when the child's age and symptoms indicate pediatric care. The server computes distances between a reference location derived from guardian or institution position information and facility locations by applying a distance formula to stored coordinates. The server filters out facilities whose distance exceeds a configured limit and ranks remaining facilities according to distance and priority attributes, optionally weighted by urgency. This geographical and specialty-based filtering is performed algorithmically, without requiring user input, and reduces the search space of external reservation interfaces, thereby reducing network traffic and processing time.

The server acquires consultation time information and reservable time information for each medical facility candidate via an external reservation-information-providing interface of a reservation-information-providing server or the facility's own reservation system. The server transmits queries over the communication network, including facility identifiers and a date range, through standardized network protocols. The server receives responses containing reservation slot data and normalizes date-time representations to a standard time zone and format. The server stores the normalized time slots as time-slot information in memory structures organized by facility, date, and status. This structured time-slot representation enables efficient scanning and comparison operations across multiple facilities and days.

The server extracts reservable time slots within consultation hours, based on time-constraint information and position information associated with the guardian. The server checks each time slot against constraints such as earliest acceptable start time, latest acceptable end time, and minimum travel time from the guardian's position to the facility position. The server discards slots that violate these conditions and maintains a list of candidate reservation time slots that satisfy all constraints. The server then calculates a value for each candidate time slot using an evaluation function. In one embodiment, the evaluation function is a weighted sum of normalized urgency scores, waiting time, travel time, and facility priority. The server computes these values using numeric operations in main memory and sorts candidate time slots in ascending order of evaluation cost, thereby determining an optimal reservation candidate time slot. By algorithmically integrating urgency, temporal constraints, and travel time, the server achieves a selection that is reproducible and tuned to system objectives, which is difficult to maintain through manual human processes, especially under high load.

The server generates a prompt sentence defining contents of reservation request data for the selected medical facility and time slot, and uses the generative AI model to generate the reservation request data. The server may include in the prompt sentence explicit instructions such as:

“Generate reservation request content for a medical appointment based on the following parameters: child name, summarized symptoms, selected date and time, and facility identifier. The content should be concise, formal, and suitable for transmission to a medical reservation system. Use complete sentences and clearly indicate the appointment time and the child's condition.”

The server populates the prompt sentence with concrete parameter values obtained from structured data and time-slot information and then transmits the prompt sentence and parameters to the generative AI model. The model outputs a formatted textual description of the reservation request, which the server incorporates into reservation request data formatted for the specific reservation-information-providing interface. The server transmits this reservation request data to the external interface. In another embodiment, the server predefines a data schema and uses the generative AI model to generate only certain portions, such as the human-readable reason description, while static fields such as facility identifiers and structured timestamps are filled deterministically by the server. This hybrid design reduces the risk of inconsistent structured fields while leveraging generative capabilities for unstructured text segments.

The server records reservation identification information and consultation date-and-time information returned by the reservation-information-providing interface into the “reservations” table, associated with the message identifier, child identifier, and facility identifier. The server also stores additional attributes, such as reservation status and facility instructions, in corresponding fields. The server then generates a notification message including reservation results and consultation guidance for the guardian. The server uses templates stored in memory and fills fields such as child name, facility name, appointment date and time, and facility address. The server transmits the notification message via an electronic mail transmission apparatus or a notification delivery apparatus to the guardian terminal over the communication network. The guardian terminal, implemented for example as a smartphone, receives the message through a mail client or push-notification subsystem and presents the information to the user via a display unit and, optionally, an audio output unit.

The server further generates a prompt sentence for automatic payment of the medical fee and utilizes the generative AI model to help form payment request data under system control. The prompt sentence may instruct the model to generate a concise explanation for the payment description field while the server computes concrete numeric fields such as amount, currency, and payment destination. For example, the server may use a prompt sentence of the form: “Create a short payment description for an electronic medical fee payment for a child's consultation, including the child's name, the date and time of the appointment, and the medical facility name. The description should be suitable for a billing statement.”

The server then transmits payment request data containing this description, the amount and other required identifiers to the electronic payment processing apparatus. The apparatus processes the payment transaction and returns a result, which the server records in the “reservations” table and in transaction records. These payment integrations are implemented with specific network protocols and data schemas defined by the payment apparatus, and the server uses structured message formats to ensure correct interfacing and to avoid the ambiguity of natural language-only instructions.

The server maintains detailed audit information to record a trace of operations and generative AI model inputs and outputs. For each major transaction (message reception, attribute extraction, facility selection, reservation execution, payment execution), the server stores a log record in the “audit_logs” table. Each record contains at least the message identifier, child identifier, facility identifier, timestamps for each step, the prompt sentences provided to the generative AI model, the model responses, and the final structured data derived from these responses. The audit information enables post hoc analysis of system behavior, error diagnosis, and verification of correctness. Because the server associates generative AI outputs with deterministic processing steps, system administrators can detect and correct cases in which generative outputs deviate from expected patterns, which contributes to improving system robustness and safety.

In another embodiment, the server obtains voice data or text data from the guardian to assess emotional state. The guardian terminal transmits digitized audio signals or textual messages to the server over the communication network. The server converts the voice data into text using an automatic speech recognition module and then constructs a prompt sentence that directs the generative AI model to classify emotional tone and intensity. A sample prompt sentence may be:

“Analyze the following text from a guardian and determine the emotional state as one of calm, moderate stress, or high stress, and provide a brief explanation: ‘I am very worried about my child and need an appointment as soon as possible.’”

The server passes the prompt sentence and text to the generative AI model and obtains a classification and explanation. The server encodes the emotional state as numerical or categorical values and uses these values to adjust parameters of the evaluation function. For instance, for high-stress states, the server increases the weight for earliest time relative to distance, whereas for calm states the server may increase weight for facility continuity or preference. This algorithmic coupling of emotion analysis and time-slot selection is executed by the server with explicit parameter adjustment and thereby represents a quantifiable, computer-implemented optimization rather than an unconstrained interpretation of user mood.

From a technical perspective, the described architecture improves computer functionality over conventional systems in several ways. By integrating rule-based parsing with transformer-based generative AI processing under prompt control, the server reduces the need to transmit entire unstructured messages to multiple external services, thereby reducing communication load and processing duplication. The server's use of internal, standardized time-slot structures and explicit evaluation functions enables more efficient sorting and filtering in memory, which decreases computational complexity compared to naive sequential search across heterogeneous formats. The persistent audit logging of prompts and outputs enhances transparency and facilitates automated anomaly detection, which, in practice, reduces time to diagnose errors and enables targeted model or rule tuning.

The server improves processing speed and accuracy in attribute extraction by constraining generative AI outputs through carefully designed prompt sentences and deterministic post-processing. The generative AI model operates with pre-trained parameters that capture rich language patterns, while the server's rule-based modules filter and validate outputs, thereby reducing semantic misinterpretations that would be common in purely rule-based or purely generative systems. The combination of advanced model architecture, explicit prompts, and structured post-processing results in more accurate and faster classification of urgency and symptom attributes, which directly improves the timeliness and appropriateness of medical facility selection.

The server also improves data management by storing normalized, structured representations of messages, attributes, and transactions in a relational schema optimized for join operations and indexed lookups. This design allows the server to efficiently handle large volumes of incoming notifications and to perform multi-dimensional queries (by child, facility, time, urgency) with lower latency, which is particularly important in distributed environments serving many institutions and guardians. By reducing manual intervention and repetitive data re-entry, the system not only saves human effort but also reduces error-prone transfers between systems that would otherwise require ad hoc copy-and-paste operations.

In an alternative embodiment, the generative AI model is an encoder-only or decoder-only transformer trained with supervised fine-tuning on domain-specific corpora including medical appointment dialogues and institutional notifications. The server stores fine-tuning datasets in the storage device and, during model training, uses an optimization algorithm such as stochastic gradient descent with adaptive moment estimation. The server defines a loss function that measures the discrepancy between predicted attribute labels or text outputs and reference annotations. During training, the server updates model weights iteratively based on gradients computed with backpropagation. Data augmentation techniques such as synonym replacement, noise injection, and paraphrasing may be used to increase robustness. Although training is typically performed offline, these details illustrate how the model is configured and optimized such that inference-time behavior is well suited for the described extraction and generation tasks.

In another variation, the server deploys multiple generative AI models specialized for different subtasks. For example, one model may focus on entity extraction from educational-institution messages, another model may specialize in emotion classification from guardian input, and another model may generate narrative descriptions for reservations and payments.

The server routes data to each model based on task type and aggregates their outputs into unified structured data. This modular architecture improves reliability and allows independent tuning of each model for its specific subtask while maintaining consistent control through prompt sentences and audit logging.

The described embodiments also enable additional technical effects regarding communication efficiency and system scalability. By pre-filtering facility candidates based on specialty, geographic proximity, and static priority before querying external reservation-information-providing interfaces, the server reduces the total number of external requests. This reduces bandwidth consumption and minimizes response latency under high system load. The server can further cache frequently requested facility schedule data with expiration times so that repeated queries within a given window do not require network access. Thus, the server decreases average network round-trip time and improves responsiveness.

The described system is not limited to a single hardware configuration. In yet another embodiment, the server is implemented as a distributed system in which separate physical or virtual machines handle message normalization, attribute extraction, facility selection, generative AI inference, and transaction processing. Communication between these machines occurs via internal network protocols. The use of message queues and asynchronous processing further supports background execution without blocking user interactions. Even in such distributed forms, the logical flow and data structures remain consistent with those described above.

A user, who is a guardian, interacts with the system through the guardian terminal only at key points, such as initial registration and optional confirmation or modification of reservations.

The system otherwise performs the above-described processing autonomously on the server side as background processes. The terminal receives and displays notifications, and the user may choose to perform further operations, such as cancelling a reservation. In that case, the server interprets the user's operation as a new transaction, updates the reservation status by interfacing with the external reservation-information-providing interface, and records corresponding audit information.

Through these embodiments and variations, the server, the terminal, and the user cooperate in a concrete, technically defined architecture that transforms unstructured institutional notifications and user signals into structured, auditable reservation and payment transactions.

The described data structures, algorithmic flows, and neural-network-based generative modules, controlled via explicit prompt sentences and deterministic post-processing, provide specific improvements in processing speed, accuracy, data management, and communication efficiency within computer systems implementing medical appointment scheduling.

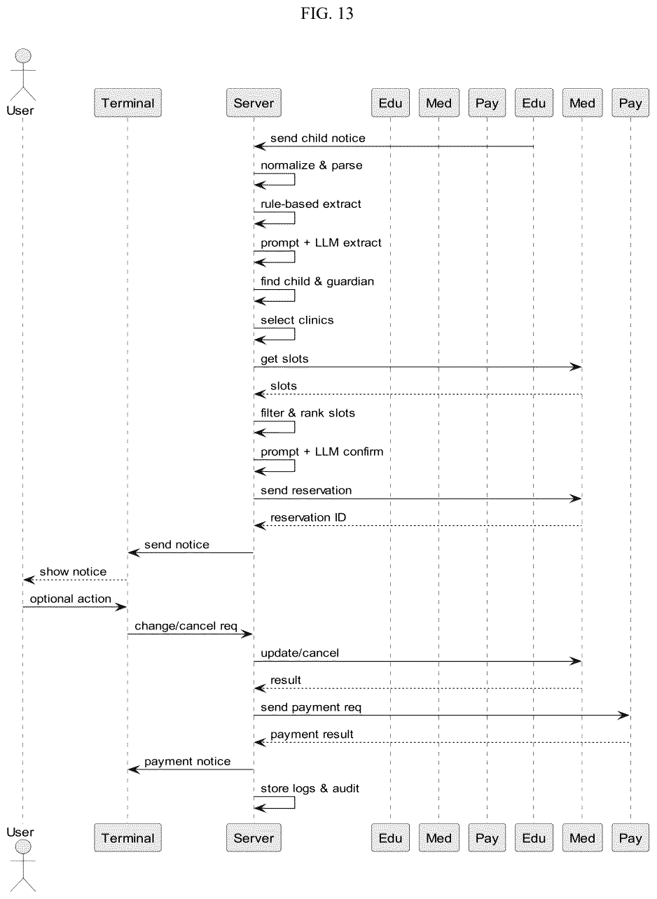

The following describes the processing flow using FIG. 13.

### Step 1:

Server receives notification information from an educational institution.

Server accepts, as input, an electronic message including at least a message body, a sender identifier, a timestamp, and optional attachments, transmitted via a communication network using a messaging protocol or webhook. Server verifies authentication headers and digital signatures, converts the raw bytes into a canonical character encoding, and parses protocol headers to separate metadata from the message body. Server outputs a normalized message object containing fields such as message_id, institution_id, raw_text, header_metadata, and received_timestamp, and stores this object in a messages table of a database.

### Step 2:

Server normalizes and stores the notification information.

Server takes, as input, the normalized message object from Step 1. Server removes unsupported control characters, strips markup tags, and replaces multiple whitespace characters with single spaces to create a cleaned_text field. Server assigns a unique internal identifier, maps the institution's external identifier to an internal institution_id, and adds normalization flags. Server performs simple language detection, if necessary, and stores the resulting internal message record, including cleaned_text and metadata, into the messages table. Server outputs a persistent internal message record that will be used as the basis for subsequent analysis.

### Step 3:

Server performs rule-based extraction of candidate attributes.

Server receives, as input, the internal message record including cleaned_text. Server applies predetermined regular expression patterns and dictionary lookups to detect candidate child names, temperature values, grade-level indicators, and key symptom words. Server uses a time-expression parser to convert phrases such as “this morning” or “around 3 μm” into approximate timestamps relative to received_timestamp. Server performs string operations and numeric conversions to transform matched substrings into typed values. Server outputs a preliminary attribute object containing candidate_child_name, candidate_symptom_phrases, candidate_temperature_values, and candidate_reported_time.

### Step 4:

Server generates a prompt sentence and invokes a generative AI model for semantic extraction.

Server takes, as input, the internal message record and the preliminary attribute object. Server constructs a prompt sentence that instructs a generative AI model to extract a child's full name, symptom list, temperature, urgency level, and a one-sentence summary. Server embeds the cleaned_text and candidate attributes into the prompt sentence as contextual information.

Server sends the prompt text to the generative AI model via an inference API and receives a textual response. Server parses the response by searching for labeled sections or delimiter phrases, and converts extracted tokens into structured fields. Server outputs structured data including child_attribute, symptom_attribute, urgency_attribute, temperature_attribute, and internal_summary_text.

### Step 5:

Server associates the child attribute with stored child and guardian information.

Server accepts, as input, the structured data from Step 4. Server queries a children table using the extracted child name and the institution_id, optionally computing similarity scores between the extracted name string and registered names using a string-distance function.

Server selects a child record whose similarity score exceeds a threshold, and then queries a guardians table using the child identifier to retrieve guardian records. Server extracts contact channels, time-constraint information, and position information from the guardian records.

Server outputs a child_guardian_context object containing child_id, guardian_id, contact_routes, time_constraints, and guardian position.

### Step 6:

Server selects medical facility candidates based on structured attributes.

Server receives, as input, the symptom_attribute, urgency_attribute, and child guardian_context. Server queries a facilities table to retrieve medical facility records including specialty attributes, location attributes, consultation patterns, and priority attributes.

Server filters the facilities by matching specialty attributes to the symptom_attribute and, if applicable, to the child's age category. Server computes distances between guardian_position or institution position and each facility location using stored coordinates. Server removes facilities that exceed a configured maximum distance, and ranks remaining facilities according to distance and priority. Server outputs a facility_candidate_list sorted by suitability score.

### Step 7:

Server obtains and normalizes time-slot information from external reservation interfaces.

Server takes, as input, the facility_candidate_list. Server iterates through each candidate and sends a request to a reservation-information-providing interface over the communication network, specifying facility identifiers and a date range. Server receives responses in heterogeneous formats (for example, different keys or time formats) and converts all date-time values into a unified time zone and format. Server constructs structured time-slot records with fields such as facility_id, slot_start_time, slot_end_time, and availability_status. Server stores these records temporarily in memory or in a time_slots table and outputs a unified time_slot_collection covering all facility candidates.

### Step 8:

Server filters candidate time slots based on guardian constraints and travel time.

Server accepts, as input, the time_slot_collection and the child guardian_context including time_constraints and guardian_position. Server calculates approximate travel times from guardian_position to each facility location using distance and a configured travel-speed parameter. Server eliminates time slots that start earlier than the earliest acceptable start time or later than the latest acceptable end time, or that do not allow sufficient travel time between current time and the slot start. Server outputs a filtered_slot_list of candidate reservation time slots that satisfy temporal and travel constraints.

### Step 9:

Server evaluates and ranks candidate time slots using an evaluation function.

Server receives, as input, the filtered_slot_list, the urgency_attribute, and facility-related parameters. Server computes, for each candidate time slot, a score generated by an evaluation function that combines normalized waiting time, normalized travel time, urgency weight, and facility priority. Server calculates each component numerically, for example, by subtracting current time from slot_start_time or by normalizing distance values, and then applies configured weights. Server sorts the candidate time slots in ascending order of score and selects the top-ranked slot as an optimal reservation candidate time slot. Server outputs an optimal_slot_selection containing the chosen time slot and a ranked list for potential backup use.

### Step 10:

Server optionally refines the selection using a generative AI model.

Server accepts, as input, the ranked list of candidate time slots and the urgency_attribute.

Server generates a prompt sentence that describes the candidate slots, the urgency level, and guardian constraints, and asks the generative AI model to confirm or adjust the selection.

Server sends the prompt and candidate slot descriptions to the model and receives a textual recommendation including a chosen slot index and a short justification. Server parses the recommendation and, based on system configuration, either adopts the suggested slot or logs the justification for audit purposes while retaining the original selection. Server outputs a final_slot_choice representing the slot that will be used for reservation.

### Step 11:

Server generates reservation request data using a prompt sentence and generative output.

Server takes, as input, the final_slot_choice, the structured data from Step 4, and facility-specific requirements. Server composes a prompt sentence instructing the generative AI model to produce a concise reservation description containing child name, summarized symptoms, and appointment time. Server inserts concrete parameter values into the prompt and sends the prompt text to the generative AI model. Server receives a natural-language description and incorporates it into reservation request data along with strictly structured fields such as facility identifier, slot_start_time, and child identifier. Server outputs a complete reservation_request object formatted to be accepted by the reservation-information-providing interface.

### Step 12:

Server executes the reservation process with the external interface.

Server accepts, as input, the reservation_request object. Server sends the reservation_request to the external reservation-information-providing interface via a network protocol and waits for a response. Server parses the response to extract reservation identification information, confirmed date-and-time information, and status codes. If the external system indicates a temporary failure, the server applies a retry policy with backoff and logs intermediate results.

Server stores confirmed reservation details in the reservations table, associated with the original message, child, and facility. Server outputs a reservation_result object containing reservation_id, consultation_date_time, facility_id, and status.

### Step 13:

Server generates and transmits a notification message to the guardian terminal.

Server receives, as input, the reservation_result and the child guardian_context. Server constructs notification content using text templates and inserts dynamic values such as child name, facility name, reservation date and time, facility address, and any special instructions.

Server chooses a communication route (for example, email or push notification) based on guardian preferences and urgency. Server transmits the notification message to the guardian terminal via an electronic mail transmission apparatus or a notification delivery apparatus over the communication network. Server outputs a notification_log entry recording transmission time, channel, and status.

### Step 14:

Terminal receives and displays the notification message.

Terminal takes, as input, the notification message delivered through the selected communication route. Terminal's communication subsystem retrieves the message from the network and passes it to a mail client or notification framework. Terminal decodes the message, renders the text and any associated metadata on a display, and optionally emits an alert sound or vibration. Terminal outputs a human-readable view that allows the user to recognize the reservation details.

### Step 15:

User reviews the reservation details and optionally initiates further actions.

User receives, as input, the human-readable notification on the terminal's display. User visually inspects the appointment time, facility information, and child name, and confirms that the reservation matches expectations. If necessary, user operates the terminal user interface to trigger follow-up actions such as requesting a change or cancellation. User input becomes a new command that the terminal sends back to the server. User outputs confirmation or modification requests that feed into subsequent server-side processing.

### Step 16:

Server generates payment request data using a prompt sentence and structured fields.

Server accepts, as input, the reservation_result, stored medical fee information, and guardian payment preferences. Server computes a payment amount, applies any contract-based rules, and constructs a payment metadata object including reservation_id and facility_id. Server generates a prompt sentence instructing the generative AI model to create a brief payment description suitable for a billing statement, using child name, appointment time, and facility name. Server transmits the prompt to the generative AI model and receives a textual description. Server embeds this description into payment request data together with numeric fields such as amount and payment destination identifiers. Server outputs a payment_request object ready for transmission to the electronic payment processing apparatus.

### Step 17:

Server executes the payment process with the electronic payment processing apparatus.

Server takes, as input, the payment_request object. Server sends the payment_request to the electronic payment processing apparatus over the communication network using a secure protocol. Server receives a payment response containing a transaction identifier, approval or rejection status, and timestamp. Server updates the reservations table and transaction information storage to record the payment status, links the payment transaction identifier to the reservation_id, and logs any error codes if the payment fails. Server outputs a payment_result object and, if configured, triggers generation of an additional notification message informing the guardian of payment completion or failure.

### Step 18:

Server generates and stores audit information for the complete transaction flow.

Server accepts, as input, intermediate objects and logs from Steps 1 through 17, including message identifiers, structured data snapshots, prompt sentences, generative AI model responses, external request payloads, and external responses. Server aggregates these pieces, assigns a correlation identifier, and constructs an audit record containing a chronological sequence of events. Server computes hash values or checksums for critical fields to support integrity checking and stores the audit record in the audit_logs table. Server outputs a persistent audit trail that can be queried by administrators or automated tools for monitoring, debugging, and compliance verification.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented reservation systems for medical or commercial facilities generally require a user to manually search facility schedules, visually compare available time slots with consulting or opening hours, and then perform a series of separate operations for reservation and payment. In such systems, processing is typically organized around static forms and simple rule-based filters, without deeply integrating dynamic schedule comparison, emotion-aware decision logic, automated payment, and multi-channel notification control into a unified computational workflow. As a result, several technical problems arise in the field of information processing systems.

First, when a server merely retrieves and displays raw schedule data to a user terminal, the server offloads complex decision-making and time-range comparison to the user. This leads to inefficient use of processor and memory resources, because the server does not exploit its capability to pre-filter, rank, and select optimal reservation slots. The user-side device is then burdened with repeated requests and updates, increasing network traffic and latency. The lack of integrated time-range calculation at the server side also impedes deterministic, low-latency selection of appropriate slots in scenarios where schedules change rapidly, such as when many users are competing for limited medical appointment times.

Second, conventional systems that attempt to incorporate user “preferences” often treat such preferences as static flags or preconfigured profiles. They do not include a robust mechanism for ingesting free-form user text or voice, generating structured prompt sentences, invoking a generative AI model to infer an emotion state, and feeding the inferred emotion state back into core scheduling and notification algorithms. In these systems, any sentiment or emotion recognition is typically performed in an ad hoc manner and is not tightly integrated with the logic that selects a facility, chooses a reservation slot, or determines a notification channel.

Consequently, the server cannot adapt its computational decision rules at runtime based on a dynamically inferred emotional context, which leads to suboptimal resource allocation and poor responsiveness to the user's situational needs.

Third, many existing architectures perform reservation, payment, and notification as logically separate workflows. Reservation processing is often completed without a direct linkage to the subsequent payment processing pipeline, and notification is handled as a generic “send message” step unrelated to emotional state or reservation context. This fragmented pipeline causes redundant data transformations, duplicate network calls, and complex client-side orchestration. It increases the possibility of inconsistent states (for example, reservation confirmed but payment not processed, or payment processed without clear reservation confirmation) and requires extensive exception handling at the application level.

Fourth, current systems generally process schedule acquisition, comparison, reservation, emotion analysis, payment, and notification in foreground or synchronous manner, interfering with user operations on the terminal. When heavy server-side computation or network communication is not decoupled via asynchronous mechanisms, the user terminal may block or become unresponsive while waiting for completion of remote tasks. This leads to degraded user experience and inefficient utilization of computing resources across server and client.

Therefore, there is a need for an improved information processing system and server architecture that (i) automatically acquires and compares consulting times and reservation reception times at the server side to select an optimal reservation candidate time period, (ii) systematically uses generative AI models via explicit prompt sentences to infer a user's emotion state from voice or text input, (iii) applies the inferred emotion state to modify selection rules for facility choice, schedule selection, and notification channel within the same computational framework, and (iv) executes reservation, payment, and notification processes asynchronously and cohesively, thereby improving overall processing efficiency, robustness, and responsiveness of the computer system itself.

The specific processing by the specific processing unit 290 of the data processing device 12 in Application Example 2 is realized by the following means.

The present invention provides a server comprising a processor configured to receive health-related notification data from an educational organization via a communication network, to parse text included in the notification data to extract structured event information relating to a protected person, to acquire consultation time information and reservation reception time information of a plurality of facilities from a storage apparatus or an external information processing apparatus and maintain such time information as a data set, to execute time-range calculation on the data set so as to extract reservation reception time candidates within a consultation time range and select an earliest reservation candidate time period in accordance with predetermined conditions, to generate and transmit a reservation-request prompt sentence to an external reservation processing apparatus or reservation service based on the selected reservation candidate time period and associated facility information, to obtain voice data or text data from a user via a user terminal and convert voice data into text data, to generate an emotion-estimation prompt sentence that provides the text data as input to a generative AI model and to identify an emotion state based on emotion type information returned from the generative AI model, to determine an optimal facility by applying selection rules that reference attribute information including at least one of evaluation information, waiting-time information, distance information, and congestion information in accordance with the identified emotion state and to generate a reservation prompt sentence reflecting the determination, to communicate with an electronic payment processing apparatus using consultation-fee information and user payment information so as to generate and transmit a payment prompt sentence that causes automatic execution of payment processing and to record payment result information, and to select a notification method from among multiple notification channels based on the emotion state, generate notification content including at least one of reservation result information and payment result information, and transmit the notification content to the user terminal for display and confirmation by the user. This enables the server-centric computing architecture to automatically integrate schedule comparison, emotion-aware facility and time selection, payment execution, and adaptive notification control into a cohesive asynchronous processing pipeline, thereby reducing client-side processing burden, improving resource utilization and response time, and enhancing robustness and adaptability of the computer system in handling reservation and payment workflows under varying user emotional conditions.

The term “educational organization” refers to an institution that supervises or cares for a protected person and that transmits health-related notifications, including but not limited to schools, childcare centers, and similar organizations.

The term “communication network” refers to a wired or wireless information transmission infrastructure that enables data exchange between the server, external systems, and user terminals, and may include public networks, private networks, or any combination thereof.

The term “notification data” refers to digital information received from an external source, including textual content or structured messages, that indicate at least a health-related event concerning a protected person.

The term “text information” refers to character-based data contained in notification data or user input, including natural language sentences, phrases, or symbols that can be processed by text analysis components.

The term “event” refers to a detected occurrence relating to a health condition of a protected person, derived from notification data or user input, and represented as structured data for further processing by the server.

The term “protected person” refers to an individual under the care or supervision of a user, such as a child, for whom health-related reservations and payments are to be managed by the system.

The term “structured data” refers to information that has been organized into a defined format, such as key-value pairs, records, or objects, enabling machine processing, searching, and relational operations.

The term “consultation time information” refers to data that specifies one or more time ranges during which a facility provides services to clients or patients, such as operating hours or service periods.

The term “reservation reception time information” refers to data that specifies one or more time ranges within which a facility accepts reservations, which may be a subset of consultation time information.

The term “storage apparatus” refers to any data retention component, including internal or external databases, memory devices, or storage services, that store facility information, time information, or other records.

The term “external information processing apparatus” refers to a computing entity outside the server, such as an external server, web service, or application programming interface, that supplies data or performs processing on behalf of the system.

The term “data set” refers to a collection of related data items, including consultation time information and reservation reception time information, organized for processing by the server.

The term “time-range calculation” refers to computational operations that compare, intersect, filter, or otherwise process time intervals, in order to determine relationships between consultation time information and reservation reception time information.

The term “reservation reception time candidates” refers to specific time intervals within reservation reception time information that satisfy given constraints, such as inclusion within a consultation time range.

The term “earliest reservation candidate time period” refers to a reservation reception time candidate with the minimum start time or priority value among candidates that satisfy predetermined conditions.

The term “predetermined condition” refers to a rule or set of rules defined in advance, such as chronological order, facility priority, or user constraints, that governs selection among multiple time candidates.

The term “reservation-request prompt sentence” refers to a text-based instruction or message that encodes parameters for a reservation request and is transmitted to an external reservation processing apparatus or reservation service.

The term “external reservation processing apparatus” refers to a computing system operated by or on behalf of a facility or service provider, which receives reservation requests and generates reservation results.

The term “reservation service” refers to an information processing service, such as an application or web-based platform, that accepts reservation requests and manages reservation records for one or more facilities.

The term “user” refers to a person operating a user terminal to manage or monitor reservations, payments, and notifications for a protected person.

The term “user terminal” refers to an end-user device, such as a smartphone, tablet, or computing device, that communicates with the server to send input data and receive output data, including notifications.

The term “voice data” refers to audio signals captured from the user's speech, which can be processed by speech recognition components to obtain corresponding text data.

The term “text data” refers to data represented as characters, words, or sentences, including user-typed input or text obtained from speech recognition processing.

The term “speech recognition processing” refers to a computational process that converts voice data into text data by analyzing acoustic features and mapping them to linguistic units.

The term “emotion-estimation prompt sentence” refers to a text string that provides instructions and input content to a generative AI model for the purpose of estimating an emotion state from text data.

The term “generative AI model” refers to a machine-learning model that receives input text and generates output text or labels, and that is capable of performing tasks such as emotion classification based on prompt sentences.

The term “emotion type information” refers to data indicating a category or label corresponding to a user's emotional state, such as anxiety, anger, hurry, relaxation, joy, or surprise.

The term “emotion state” refers to an internal representation used by the server that corresponds to emotion type information and is used to influence subsequent decision processes.

The term “medical-related facility” refers to an establishment that provides health or medical services, such as a clinic, hospital, or similar service provider.

The term “facility information” refers to data describing a facility, including identifiers, location, ratings, average waiting times, and other attributes relevant to reservation selection.

The term “attribute information” refers to data associated with a facility or time slot, including evaluation information, waiting-time information, distance information, congestion information, or similar metrics.

The term “evaluation information” refers to data that represents qualitative or quantitative assessments of a facility, such as ratings, reviews, or quality scores.

The term “waiting-time information” refers to data indicating expected or historical waiting durations associated with a facility or time slot.

The term “distance information” refers to data describing a spatial separation or travel effort between a user or protected person and a facility.

The term “congestion information” refers to data indicating an expected or measured level of crowding or load at a facility or during a particular time period.

The term “selection rule” refers to a decision-making criterion or algorithm that uses attribute information and context, such as emotion state, to determine a preferred facility or time slot.

The term “consultation quality priority” refers to a selection rule that emphasizes higher evaluation information or service quality when comparing facilities or time slots.

The term “waiting-time shortening priority” refers to a selection rule that emphasizes shorter waiting-time information when comparing facilities or time slots.

The term “congestion avoidance priority” refers to a selection rule that emphasizes lower congestion information or less crowded time slots when comparing facilities or time slots.

The term “reservation prompt sentence” refers to a text-based instruction that encodes a selected facility and time slot, formatted for use by a downstream reservation system or process.

The term “electronic payment processing apparatus” refers to a computing system or service that processes digital payment transactions, such as credit-card payments or electronic transfers.

The term “consultation-fee information” refers to data specifying monetary charges associated with a consultation or service provided by a facility.

The term “user payment information” refers to data required for performing electronic payment on behalf of the user, such as tokenized account details or payment method identifiers.

The term “payment prompt sentence” refers to a text-based instruction that encodes parameters of a payment request and is transmitted to an electronic payment processing apparatus.

The term “payment result information” refers to data returned from an electronic payment processing apparatus that indicates the outcome of a payment transaction, including success, failure, or error codes.

The term “notification method” refers to a communication channel used to convey information from the server to the user terminal, such as electronic mail, short-range wireless communication, voice call, or on-screen display.

The term “electronic mail notification” refers to a notification method in which message content is transmitted as an email message to an address associated with the user.

The term “short-range wireless communication notification” refers to a notification method in which message content is transmitted using a short-range wireless technology or push protocol to a user terminal.

The term “voice-call notification” refers to a notification method in which the user is contacted via a voice communication channel and message content is delivered audibly.

The term “terminal-screen-display notification” refers to a notification method in which message content is presented visually on a display of the user terminal.

The term “notification content” refers to digital information generated by the server that includes at least reservation result information, payment result information, or both, and may be formatted according to the selected notification method.

The term “reservation result” refers to data indicating the outcome of a reservation process, including confirmed times, facility identifiers, reservation identifiers, and status.

The term “payment result” refers to the portion of payment result information that summarizes whether a payment for a reservation or consultation has been successfully processed.

The term “confirmation operation” refers to an input action performed by the user on the user terminal to acknowledge, approve, or review one or more of the reservation result, payment result, or notification content.

The term “asynchronous processing mechanism” refers to a computational technique or framework that allows tasks to be initiated and executed without blocking other operations, enabling multiple processes, such as acquisition, calculation, reservation, payment, and notification, to progress in parallel or independently.

The term “work processing by the user” refers to operations or tasks that the user performs on the user terminal unrelated to immediate reservation, payment, or notification handling, such as job-related activities or other application usage.

The term “emotion-analysis prompt sentence” refers to a text string that is specifically formatted to instruct a generative AI model to analyze user-provided text or speech-derived text and to return emotion type information.

The term “text response” refers to output generated by a generative AI model in response to a prompt sentence, expressed as one or more textual tokens or strings.

The term “reservation candidate time period” refers to a time interval that is considered a possible reservation time based on time-range calculation and selection rules, prior to final confirmation.

In one embodiment, a server implements the claimed system as a networked information processing apparatus comprising at least one processor, a memory, a non-volatile storage device, and one or more communication interfaces. The server executes an operating system such as a general-purpose server operating system, and an application stack including a web framework (for example, a framework comparable to Flask), a database management system (for example, a relational database system comparable to MySQL, PostgreSQL, or SQLite), a key-value or document store (for example, a service comparable to Firebase), and one or more client libraries for accessing external application programming interfaces including a generative AI model API, a speech-to-text API, a reservation API, and an electronic payment API.

The server stores program modules in the non-volatile storage device, the program modules including at least a notification ingestion module, a schedule acquisition module, a time-range calculation module, an emotion analysis module, a facility and slot selection module, a reservation integration module, a payment integration module, and a notification control module. The memory stores, during runtime, data structures manipulated by these modules, including structured event records, timetable data sets, user profile records, facility attribute records, and emotion state records.

The server uses a database management system to manage multiple logical tables or collections. The server stores, for example, notification records with fields such as notification_id, source_organization_id, raw_text, and timestamp; event records with fields such as event_id, protected_person_id, symptom_type, severity_score, and reported_time; timetable records with fields such as facility_id, date, consultation_start_time, consultation_end_time, reservation_start_time, reservation_end_time, and slot_status; facility attribute records with fields such as facility_id, rating_score, average_waiting_minutes, distance_kilometers, and congestion_index; user records with fields such as user_id, contact_addresses, and payment_tokens; and emotion records with fields such as user_id, event_id, emotion_label, and confidence_score.

The server employs a data-processing framework such as a numerical or tabular processing library comparable to Pandas in order to represent consultation time information and reservation reception time information as tabular data structures. The server converts JSON responses from external facility systems into in-memory data frames whose columns include facility_id, date, consultation_start_time, consultation_end_time, reservation_start_time, reservation_end_time, and slot_identifier. The server encodes time values as numeric or timestamp types and maintains these values in contiguous memory layouts to allow efficient vectorized comparison and filtering operations.

The server performs time-range comparison by executing Boolean operations across entire columns rather than iterating over individual records. For instance, the server computes a Boolean mask where each element indicates whether a reservation_start_time is greater than or equal to a corresponding consultation_start_time and whether a reservation_end_time is less than or equal to a corresponding consultation_end_time. By using column-wise operations and indexing, the server reduces the number of conditional checks required and thereby improves processing throughput and cache utilization compared to naive per-record loop logic. This improvement is particularly beneficial when the server handles a large number of facilities and high-frequency schedule updates.

The server stores, in a configuration store, selection rules that map an emotion state to different weighting schemes over facility attributes. For example, the server stores a first rule that, for an emotion state corresponding to “anxiety,” assigns a higher weight to rating_score and a lower weight to distance_kilometers; a second rule that, for an emotion state corresponding to “anger,” assigns a higher weight to average_waiting_minutes with negative weight (shorter is better) and a lower weight to rating_score; and a third rule that, for an emotion state corresponding to “relaxation,” assigns a higher weight to congestion_index with negative weight (lower congestion is better). The server calculates, for each candidate facility and slot, a composite score by performing a weighted sum of normalized attribute values. In addition, the server constrains candidate slots to those previously identified as valid based on the time-range calculation, thereby tightly coupling emotion-dependent scoring with schedule feasibility.

The server implements the emotion analysis module as an interface to a generative AI model hosted on an external or internal computing platform. The generative AI model is, in one embodiment, a transformer-based neural network comprising multiple attention layers, feed-forward sub-layers, and layer normalization units. The generative AI model is pretrained on large-scale text corpora and then optionally fine-tuned on labeled emotion datasets where input text is annotated with discrete emotion categories such as “anxiety,” “anger,” “hurry,” “relaxation,” “joy,” and “surprise.” During fine-tuning, the server or an associated training environment uses a cross-entropy loss function between predicted emotion logits and ground-truth labels, and updates model weights using a gradient-based optimization algorithm such as an adaptive learning-rate optimizer. The server may employ data augmentation strategies, such as synonym replacement, paraphrasing, and back-translation, to increase robustness of the emotion classifier to linguistic variation.

The server generates a prompt sentence to control the generative AI model. For example, the server constructs the following prompt sentence:

“Classify the dominant emotion in the following caregiver message into one label from [anxiety, anger, hurry, relaxation, joy, surprise]. Only output the label. Message: ‘I am really worried about my child's fever and I need help quickly.’”

The server transmits the prompt sentence and associated parameters, such as a maximum output length and a deterministic generation setting (for example, temperature equal to zero in a sampling-based model), to the generative AI model through an API request. The server receives a textual response and parses the response to extract a single emotion label. By constraining the output format through the prompt sentence and by post-processing the output to match one of the predefined labels, the server reduces ambiguity and error in downstream logic.

The server executes the emotion analysis module in a separate process or asynchronous task queue. The server thereby prevents the main request-handling thread from blocking while awaiting the outcome of the generative AI model. The server correlates the emotion state with the user, the event, and the facility candidates using internal identifiers and stores the emotion state in the emotion record table. The server can reuse the stored emotion state across multiple subsequent requests, reducing repetitive calls to the generative AI model and lowering network and computation load.

The terminal is implemented as a portable computing device, such as a smartphone or tablet, executing a client application. The terminal application is developed using a cross-platform framework comparable to React Native or a web stack including markup and scripting languages. The terminal incorporates modules for user interface rendering, voice capturing, local data caching, and communication with the server via secure protocols.

The terminal captures voice data using a built-in microphone and encodes the audio in a compressed format suitable for transmission. The terminal can optionally call an external speech-to-text API to convert audio to text locally or may transmit the audio to the server for centralized conversion. When the terminal performs local conversion, the terminal reduces server load and network bandwidth used for audio streaming; when the server performs conversion, the system centralizes model management and update operations. The terminal transmits resulting text data, along with session identifiers and user identifiers, to the server for processing.

The user interacts with the terminal to view reservation results, payment status, and notifications. The terminal renders, for example, a dedicated view showing facility name, address, consultation time, reservation identifier, fee amount, and payment status. The terminal also displays short textual messages generated based on prompt sentences. For example, the server may construct a prompt sentence:

“Generate a concise, reassuring message informing a caregiver that their child's clinic appointment at 15:00 has been confirmed and paid. The caregiver feels anxious. Output only the message text.”

The server transmits this prompt to the generative AI model, receives a natural language response, and sends the resulting message text to the terminal. The terminal then displays this message in a notification view, improving perceived clarity and comfort for the user. The use of a generative AI model in this manner is integrated with the scheduling and payment logic: the same emotion state that influences facility and slot selection also parameterizes the tone and content of the notification.

The server coordinates reservation processing with external reservation systems. The server formats reservation data according to facility-specific schemas and transmits it over standardized protocols. In some embodiments, the server transmits requests encoded in a structured data format with fields representing patient identifiers, facility identifiers, service types, and selected times. By computing and sending minimal necessary fields and by reusing established connections, the server reduces overhead and latency in communication with external systems. When a reservation is confirmed, the server receives confirmation codes and updates the local reservation record, maintaining strong consistency between internal and external states.

The server integrates with electronic payment processing systems. The server stores pseudonymous payment tokens in the user record and transmits these tokens along with charge amounts and metadata to an external payment processor. The server constructs a payment prompt sentence when the system architecture employs a generative AI layer for code or request generation. For example, the server may internally generate a text such as: “Create a payment request for the consultation fee of 6000 units using the stored payment token for this user and mark the transaction as ‘medical’. Ensure idempotency by using the reservation identifier as an idempotency key.”

The server then translates this generated description into the structured request expected by the payment API. By centralizing payment logic in the server and by using idempotency keys, the system avoids duplicate charges and ensures atomicity between reservation confirmation and payment.

The server selects notification methods based on the stored emotion state. If the emotion label indicates high urgency or surprise, the server may select a notification method with a higher likelihood of immediate attention, such as a voice-call notification using a telephony API. If the emotion label indicates relaxation or joy, the server may select a less intrusive method, such as an email notification or an in-app notification. The server thereby modifies the scheduling of network calls, QoS parameters, and message formats. The coupling between emotion state and notification channel choice results in more efficient use of communication resources because urgent and non-urgent messages are sent over appropriate channels.

The server improves computer technology by introducing a data flow that aligns complex schedule evaluation, emotion analysis, and multi-channel notification control into a single, optimized pipeline. By using vectorized time-range operations in a tabular data structure, the server significantly reduces CPU instructions per facility-slot comparison and minimizes memory access overhead. By caching emotion states and facility attribute scores, the server reduces redundant computation and network calls to external AI and facility services. This architecture lowers average response latency and allows the server to handle more concurrent reservation requests with the same hardware resources.

The server further improves accuracy by employing an emotion classifier with explicit training methods and error-correction strategies. Because the generative AI model is fine-tuned with a cross-entropy objective and trained using diverse annotated samples, it exhibits lower misclassification rates than simple keyword-based sentiment heuristics. Lower misclassification leads to more appropriate selection rules being applied, which in turn yields facility and time slot choices that better match user expectations. The server quantifies confidence scores returned by the generative AI model and, if the confidence score falls below a threshold, falls back to default neutral rules instead of risking misaligned behavior.

This conditional logic reduces the rate of undesired facility assignments and unnecessary re-bookings.

The terminal and the server cooperate to avoid overloading the user device. The server executes most heavy computations—time-range calculation, attribute weighting, emotion classification, facility ranking—in a background, asynchronous fashion. The terminal receives only pre-filtered and prioritized options and final decisions from the server, reducing local CPU and battery usage. Because the server splits tasks into non-blocking operations and the terminal does not wait synchronously for each remote call, user interactions on the terminal remain responsive even when the server is handling multiple remote API calls or batch computations.

In alternative embodiments, the server deploys the generative AI model locally instead of via a remote service. In this case, the server maintains a model execution engine, GPU or accelerator hardware, and a local model repository. The server divides the model into an encoder that maps text to hidden representations and a classification head that outputs emotion logits. The server can prun or quantize model weights to reduce memory footprint and inference time. The server can also fine-tune or retrain the classification head periodically based on anonymized user feedback, thus adapting emotion inference to the specific linguistic patterns of the user population.

In yet another embodiment, the server uses a hybrid decision mechanism where a lighter-weight rule-based or statistical model pre-filters obvious cases and invokes the generative AI model only for ambiguous inputs, further reducing computational load. Similarly, the server can use a hierarchical time-range selection algorithm that first coarsely filters slots at the day level, then at the hour level, and finally at the minute level, minimizing the cost of detailed comparisons.

The system as described is not limited to medical facilities. The server can operate with commercial facilities, such as service providers or retail outlets, by interpreting consultation time information as opening hours and reservation reception time information as booking intervals. The same emotion-based weighting, time-range calculation, and multi-channel notification logic applies. By reusing the same data structures and algorithms, the server achieves code reuse and uniform performance optimizations across application domains.

Because the server defines specific data structures, asynchronous workflows, and AI-integration mechanisms that are not simple automation of human decision-making, the system improves the functioning of a computer network as a whole. The server coordinates multiple external systems (schedule providers, generative AI services, payment processors, telephony services) using optimized data transformations and selection rules that would not be practical to perform manually in real time. The causal relationship between vectorized time-range computation, emotion-aware weighting, and asynchronous, channel-specific notifications yields improvements in processing speed, selection accuracy, and communication efficiency, thereby providing a concrete technical effect beyond an abstract idea or a mere business method.

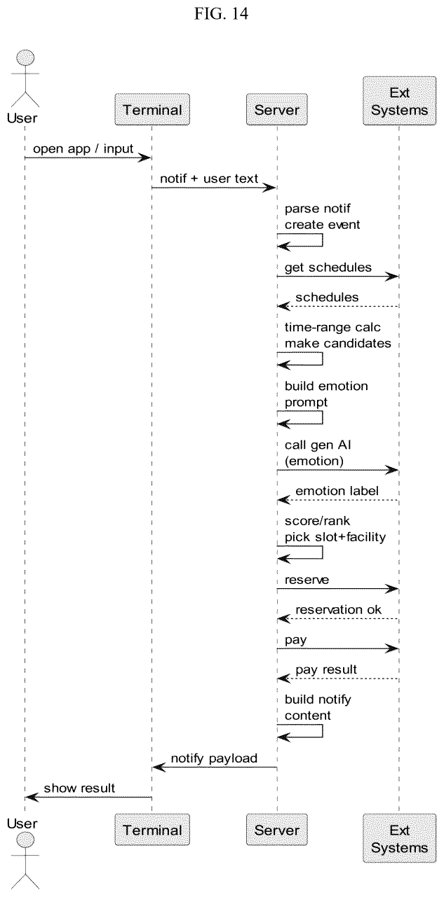

The following describes the processing flow using FIG. 14.

### Step 1:

Server receives notification data from an educational organization via a communication network.

Server takes, as input, message packets including at least a sender identifier, a timestamp, and text information describing a protected person's condition.

Server parses the message body using a text-processing routine, removes protocol headers, normalizes character encoding, and splits the text into sentences and tokens.

Server performs pattern matching and basic natural language processing to detect health-related phrases and associated values (for example, temperature, symptom keywords).

Server generates, as output, a structured event record containing fields such as event_id, protected_person_id, symptom_type, severity_score, and reported_time, and stores this event record in a database.

### Step 2:

Server acquires facility schedule information related to the event.

Server takes, as input, the event record from Step 1 and protected-person profile data including address and preferred facility categories.

Server queries internal or external storage for multiple facilities, retrieving consultation time information and reservation reception time information for facilities near the protected person.

Server receives, as raw data, schedule records in a semi-structured format (for example, JSON) and converts them to a normalized internal representation.

Server produces, as output, a timetable data set in which each record includes facility_id, date, consultation_start_time, consultation_end_time, reservation_start_time, reservation_end_time, and slot_identifier, and stores this data set in memory and optionally in persistent storage.

### Step 3:

Server performs time-range calculation to identify valid reservation candidates.

Server takes, as input, the timetable data set from Step 2.

Server loads the timetable into a tabular data structure, assigns each time field a standardized timestamp or numeric representation, and computes Boolean conditions indicating whether each reservation_start_time is greater than or equal to consultation_start time and reservation_end_time is less than or equal to consultation_end_time.

Server filters rows where these conditions are satisfied and sorts the remaining rows by date and start time.

Server generates, as output, a list of reservation reception time candidates, each including facility_id, slot_identifier, start_time, and end_time, constrained to fall within consultation times.

### Step 4:

Server selects an initial earliest reservation candidate time period.

Server takes, as input, the list of reservation reception time candidates from Step 3.

Server groups candidates by facility or evaluates them globally, applies predetermined rules (for example, earliest by start_time or earliest that satisfies a minimum lead time), and computes a minimum start_time across candidates.

Server selects the candidate with the earliest start time value and marks this as a provisional reservation slot.

Server produces, as output, a provisional reservation record that references a specific facility_id, start_time, end_time, and event_id.

### Step 5:

Terminal collects user input and optional voice data for emotion analysis.

Terminal takes, as input, user interactions on the device screen and optional audio signals from a built-in microphone.

Terminal presents a user interface prompting the user to enter free-text comments about the situation (for example, “I am very worried” or “I am extremely busy today”) and to optionally press a button to record a short voice message.

Terminal encodes the recorded audio in a compressed format and either sends the audio to the server or calls a speech-to-text service to convert the audio into text locally.

Terminal generates, as output, a payload containing user text data (typed or transcribed), a user identifier, and a session identifier, and transmits this payload to the server.

### Step 6:

Server normalizes user text for emotion analysis.

Server takes, as input, the payload from Step 5, which includes user text data and identifiers.

Server performs text normalization operations: converting to a standardized case, removing extraneous whitespace and control characters, and optionally applying tokenization or sentence segmentation.

Server may also truncate or summarize excessively long inputs using a rule-based summarizer, ensuring that the text remains within a maximum length suitable for the generative AI model.

Server produces, as output, a cleaned text string that accurately reflects the user's statements and is ready for input into a generative AI model.

### Step 7:

Server generates a prompt sentence for emotion estimation by a generative AI model.

Server takes, as input, the cleaned text string from Step 6.

Server constructs a prompt sentence that encodes both task instructions and the user's text, for example:

“Classify the dominant emotion in the following caregiver message into one label from [anxiety, anger, hurry, relaxation, joy, surprise]. Only output the label. Message: ‘I am really worried about my child's fever and I need help quickly.’”

Server concatenates static instruction templates with the dynamic user text and ensures that the prompt format is compatible with the expected input format of the generative AI model.

Server outputs a final prompt sentence string and passes it, along with configuration parameters (such as temperature and maximum tokens), to the generative AI model via an API call.

### Step 8:

Server receives and interprets emotion results from the generative AI model.

Server takes, as input, the text response returned by the generative AI model in Step 7.

Server parses the response, trims whitespace, and applies a validation routine that compares the result against a predefined set of emotion labels (for example, “anxiety,” “anger,” “hurry,” “relaxation,” “joy,” “surprise”).

Server maps equivalent or near-synonymous outputs to supported labels and, if the response does not match any known label, assigns a default neutral label.

Server generates, as output, an emotion state record comprising user_id, event_id, emotion_label, and an optional confidence score, and stores this record in a database.

### Step 9:

Server computes facility attribute scores under emotion-dependent selection rules.

Server takes, as input, the emotion state record from Step 8, the reservation candidates from Step 3, and facility attribute records from storage.

Server retrieves, for each candidate, attribute values such as rating_score, average_waiting_minutes, distance_kilometers, and congestion_index.

Server selects a weighting scheme based on the emotion_label; for instance, for “anxiety” the server assigns a higher weight to rating_score, for “anger” the server assigns a higher weight to short average_waiting_minutes, and for “relaxation” the server assigns a higher weight to low congestion_index.

Server normalizes each attribute across candidates (for example, by min-max normalization), multiplies each normalized attribute by its corresponding weight, and sums the weighted attributes to obtain a composite score per candidate.

Server produces, as output, a ranked list of reservation candidates, each with a composite score that reflects both schedule feasibility and emotion-dependent preferences.

### Step 10:

Server selects an optimal facility and reservation slot using the ranked list.

Server takes, as input, the ranked list of candidates from Step 9 and the provisional reservation record from Step 4.

Server compares the top-ranked candidate with the provisional earliest slot and evaluates any constraints, such as maximum allowable distance or maximum delay from the current time.

Server applies decision logic that may accept a slightly later but significantly higher-scoring slot (for example, for high “anxiety” with much better rating_score) or retain the absolute earliest slot (for example, for “hurry”).

Server generates, as output, a final reservation decision that specifies a chosen facility_id, start_time, end_time, and associated justification attributes, and stores this decision in a reservation planning record.

### Step 11:

Server generates a reservation-request prompt sentence and integrates with a reservation system.

Server takes, as input, the final reservation decision from Step 10 and any required patient or user data.

Server forms a reservation-request prompt sentence that describes the reservation operation to be performed, for example:

“Book an appointment at facility F123 for patient P456 on 2026 Feb. 10 at 15:00 for a pediatric consultation related to fever.”

Server translates this prompt sentence or its structured equivalent into the request format expected by an external reservation processing apparatus, populating parameters such as facility identifier, service type, and selected time.

Server sends the formatted request via a web API or other protocol, and receives, as output, a reservation confirmation or error response, which it records in the reservation planning record.

### Step 12:

Server finalizes and stores reservation details.

Server takes, as input, the reservation confirmation response from Step 11.

Server extracts fields such as external_reservation_id, confirmed_start_time, confirmed_end_time, and status_code.

Server updates the internal reservation record to include the external reservation_id and to mark the reservation as confirmed, pending, or failed based on status_code.

Server generates, as output, a confirmed reservation record that is associated with the event, the user, and the protected person, and stores this record in persistent storage for subsequent payment and notification processing.

### Step 13:

Server prepares and executes electronic payment processing.

Server takes, as input, the confirmed reservation record from Step 12 and consultation-fee information for the selected facility and service type.

Server retrieves user payment information, such as a payment token, from the user profile record, and constructs a payment prompt sentence, for example:

“Create a payment request for the consultation fee of 6000 units using the stored payment token for this user, and associate the transaction with reservation ID R789.”

Server translates the payment prompt sentence into the structured request required by an electronic payment processing apparatus and submits the request.

Server receives, as output, payment result information including transaction_id, status, and error codes if any, and records this information in a payment record associated with the reservation.

### Step 14:

Server selects a notification method based on the emotion state and processing results.

Server takes, as input, the emotion state record from Step 8, the confirmed reservation record from Step 12, and the payment record from Step 13.

Server applies notification-selection rules that map emotion labels to preferred channels; for example, for “anxiety” or “surprise” the server selects a more immediate channel such as push notification or voice call, and for “relaxation” or “joy” the server may select email or in-app notification.

Server evaluates the availability of each channel (for example, whether a verified phone number exists) and chooses the most suitable method without violating user preferences.

Server generates, as output, a notification plan specifying channel type, destination address, and priority level.

### Step 15:

Server generates notification content, optionally using a generative AI model.

Server takes, as input, the notification plan from Step 14 and the reservation and payment results.

Server constructs a notification template filled with structured fields such as facility name, date, time, fee amount, and payment status.

Server may additionally create a prompt sentence to obtain natural-language text suitable for the user's emotion state, for example:

“Generate a concise, reassuring message informing a caregiver that their child's clinic appointment at 15:00 has been confirmed and paid. The caregiver feels anxious. Output only the message text.”

Server sends this prompt sentence to a generative AI model, receives a generated message string, and embeds this string into the notification content.

Server produces, as output, a complete notification payload that includes both structured data and natural-language text.

### Step 16:

Server transmits the notification payload to the terminal over the selected channel.

Server takes, as input, the notification payload from Step 15 and the selected notification method from Step 14.

Server invokes the corresponding communication interface, such as an email gateway, a push-notification service, or a telephony interface, and formats the message according to channel-specific requirements.

Server transmits the message and awaits confirmation or delivery status when supported.

Server generates, as output, a delivery status record that indicates success or failure and logs the time and channel used.

### Step 17:

Terminal receives and presents the notification to the user.

Terminal takes, as input, the incoming message from the server via the selected channel.

Terminal decodes the notification content, verifies integrity where applicable, and extracts reservation details and message text.

Terminal presents the information on a display or via audio output, showing fields such as appointment time, facility details, and payment status, along with the generated message.

Terminal generates, as output, a user interface state reflecting that the notification has been displayed, and may log a local timestamp or send an acknowledgment back to the server.

### Step 18:

User reviews and optionally confirms or modifies the reservation.

User takes, as input, the visual or auditory information presented by the terminal in Step 17.

User reads or listens to the message, verifies that the facility, time, and fee match expectations, and may operate controls such as “Confirm,” “Request Change,” or “Cancel.”

User's selection is captured by the terminal as interaction events, and the terminal transmits these events as structured commands (for example, confirmation or modification requests) to the server.

User produces, as output, explicit confirmation data or adjustment requests that drive any further processing by the server.

### Step 19:

Server processes user confirmation or adjustment requests.

Server takes, as input, the user commands from Step 18 and the current reservation and payment records.

Server, for a confirmation, marks the reservation as user-acknowledged and may reduce the need for subsequent reminders; for a modification or cancellation, the server initiates additional schedule searches, updates or cancels reservations with external systems, and, if necessary, issues refund or adjustment requests to the payment processor.

Server updates internal records to reflect the new state and may regenerate notifications to inform the user of revised arrangements.

Server generates, as output, updated reservation, payment, and notification records that maintain consistency across all subsystems.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

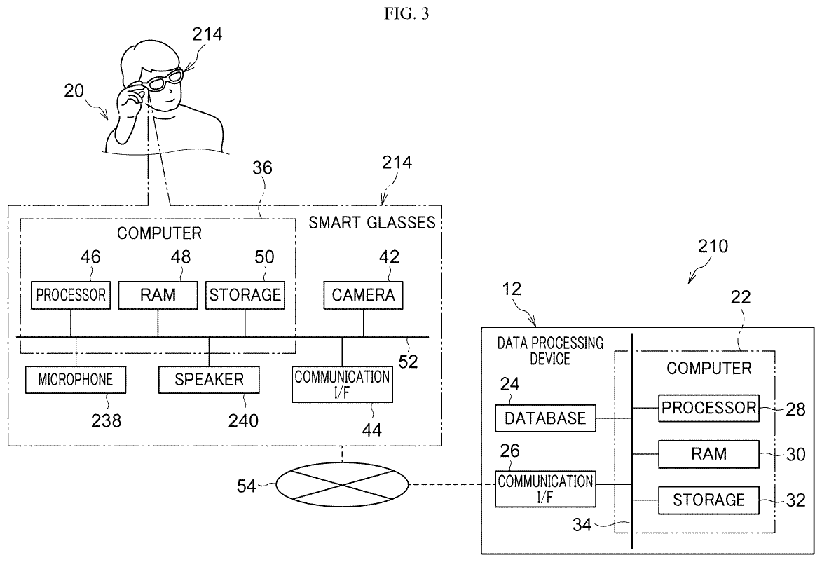

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

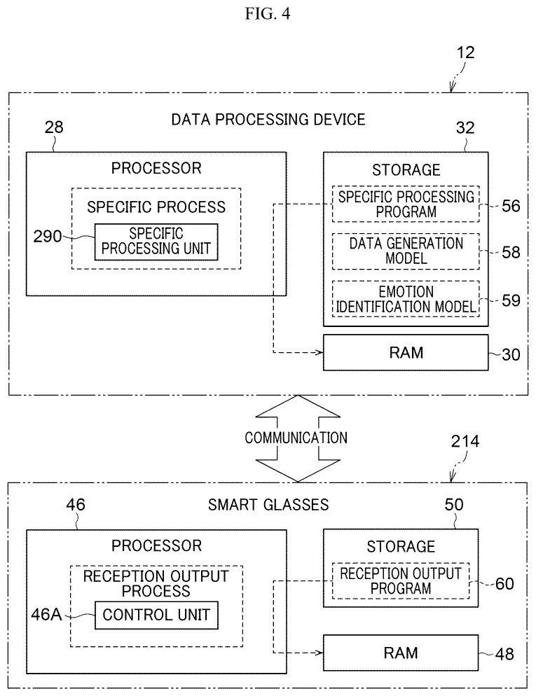

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

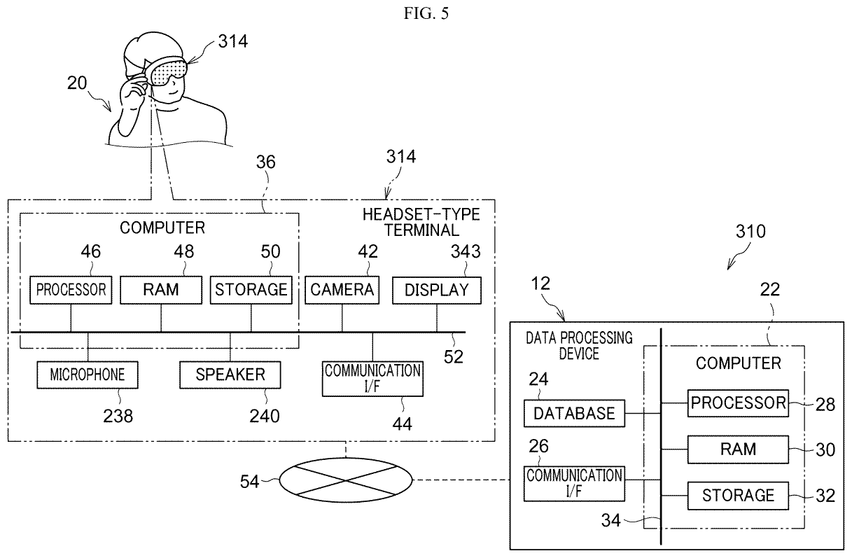

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

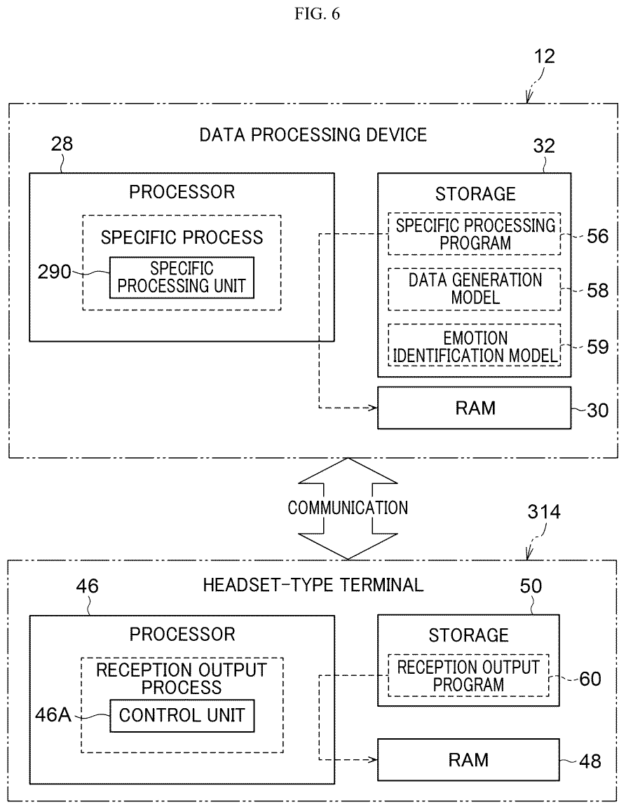

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like.

The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

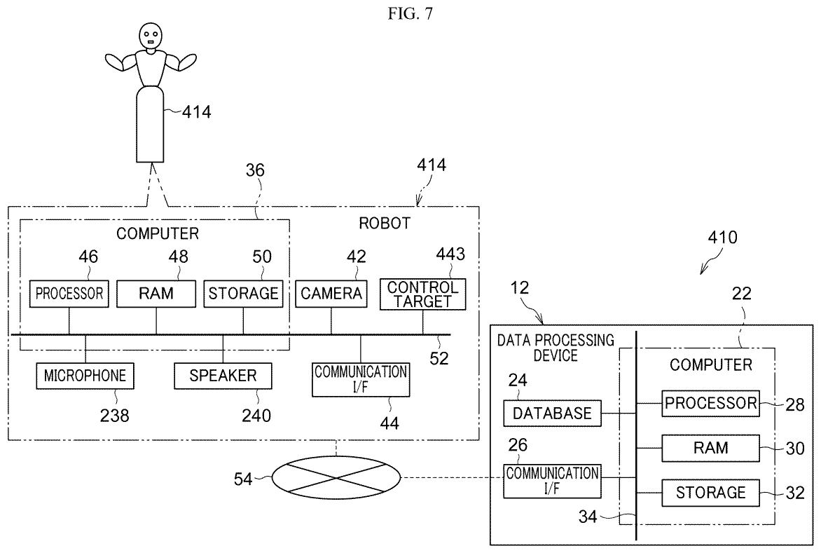

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

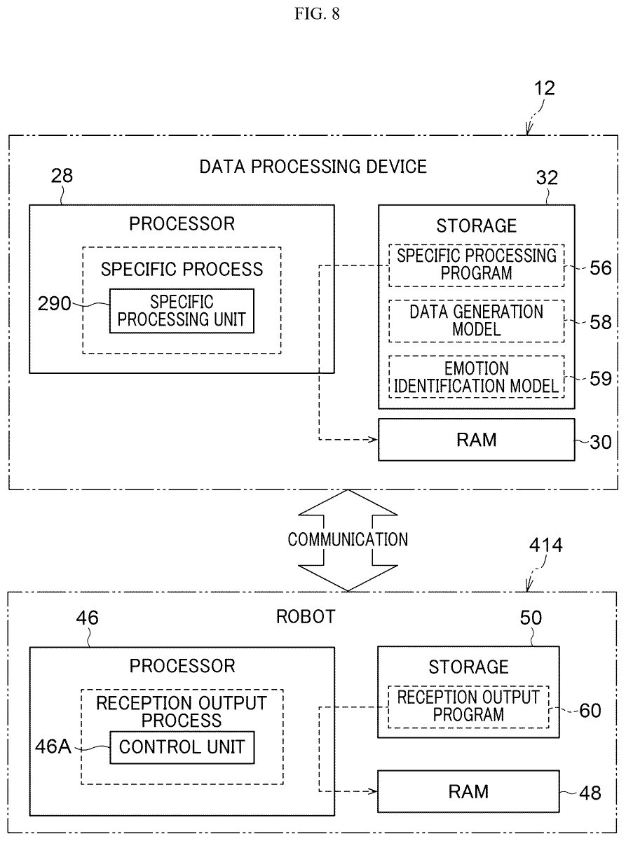

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

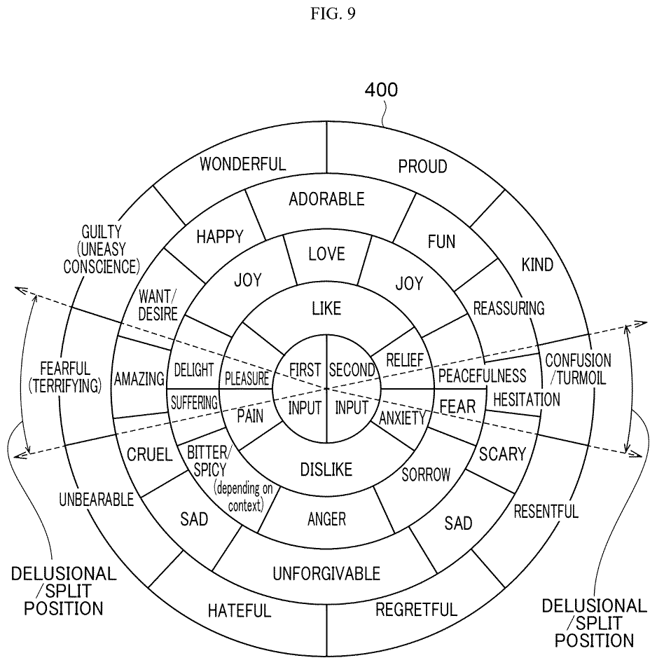

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

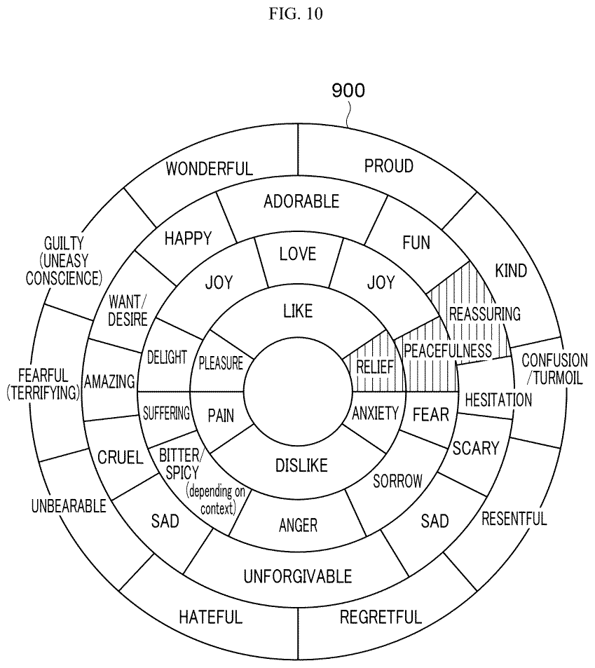

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive, via a communication network, condition information regarding a protected individual from an education-related institution and store the condition information as structured data in a storage device,
access an information storage device in which attribute information regarding a plurality of medical service providers is stored, and acquire operation information including treatment service hours and reservable time periods, on the basis of the condition information and location information associated with the protected individual,
extract available time periods within the treatment service hours on the basis of the acquired treatment service hours and the reservable time periods, and automatically select an optimal reservation time period by performing scoring processing according to a predetermined evaluation rule,
execute a reservation confirmation process by using reservation generation data including the optimal reservation time period and identification information of a medical service provider to transmit a reservation request to an external reservation management apparatus providing an interactive communication interface and acquire reservation identification information and confirmation information,
generate notification data including the reservation identification information and the confirmation information after the reservation confirmation process, and transmit the notification data to a portable information processing terminal by using at least one of a push-type notification, a short message, and an electronic mail,
acquire, from a user, audio data or character data associated with the condition information and the reservation generation data, generate an emotion analysis prompt sentence for a generative information processing model using the audio data or the character data as input, input the emotion analysis prompt sentence to the generative information processing model, and generate a prompt sentence for dynamically changing at least one of the evaluation rule and a selection condition for the medical service provider on the basis of an emotion analysis result obtained from the generative information processing model,
determine fee information related to provision of treatment service on the basis of a result of the reservation confirmation process, and execute an electronic fee settlement process by generating a settlement processing prompt sentence including the fee information and the reservation identification information and transmitting the settlement processing prompt sentence to an external settlement management apparatus,
operate, as background processing, at least a part of a condition information reception process from the education-related institution, an operation information acquisition process for the medical service providers, the reservation confirmation process, and the fee settlement process while the user executes other information processing tasks, and
generate an explanation generation prompt sentence for the generative information processing model by using at least a part of the condition information, the reservation generation data, the emotion analysis result, and information related to the fee settlement process as input information, input the explanation generation prompt sentence to the generative information processing model, and include natural-language explanation information obtained from the generative information processing model in the notification data.

### (Supplementary 2)

The system according to supplementary 1,
wherein the processor is configured to
automatically extract candidate medical service providers corresponding to the protected individual on the basis of the condition information received from the education-related institution, acquire the treatment service hours and the reservable time periods for each candidate medical service provider, store a selection result of the optimal reservation time period in a form comparable among the candidate medical service providers, and perform control to switch a medical service provider that is a transmission target of the reservation request by changing a priority order among the candidate medical service providers in accordance with the emotion analysis result.

### (Supplementary 3)

The system according to supplementary 1,
wherein the processor is configured to
generate the emotion analysis prompt sentence to be input to the generative information processing model so as to include, in addition to expressions contained in the audio data or the character data, context information including the condition information, the reservable time periods, the treatment service hours, and past reservation history information, and perform control to change at least one of selection of the optimal reservation time period, a representation format of the notification data, and an execution timing of the fee settlement process on the basis of the emotion analysis result output from the generative information processing model.

### Application Example 1

### (Supplementary 1)

A system comprising a processor,
wherein the processor is configured to
acquire, via a communication network, notification data from an education-related facility, the notification data including state information relating to a child, perform text analysis on the notification data to extract information relating to a health condition of the child, and generate a prompt sentence for specifying a medical-related facility based on the extracted information,
acquire, from a data storage device, consultation time information of a plurality of medical-related facilities based on the extracted information and user registration information, compare a current time or a notification reception time with the consultation time information to automatically calculate an earliest reservable time slot within a consultation time, generate a prompt sentence for generating online reservation information including the time slot and a corresponding medical-related facility, input the prompt sentence into a generative AI model to obtain reservation execution parameters, and automatically execute a reservation process for an online reservation function of the medical-related facility based on the reservation execution parameters,
acquire voice data or text data of a user, generate a prompt sentence using the voice data or the text data as input, input the prompt sentence into the generative AI model to obtain an emotion analysis result indicating an emotional state of the user, and generate facility selection parameters for selecting an optimal medical-related facility from the plurality of medical-related facilities based on the emotion analysis result and the consultation time information,
after completion of the reservation process, generate a prompt sentence including reservation result information and settlement information of the user, input the prompt sentence into the generative AI model to obtain electronic settlement processing parameters, and automatically execute a settlement process relating to a medical fee for an external settlement system having an electronic settlement function based on the electronic settlement processing parameters,
acquire, from the data storage device, business hour information and menu information relating to a food-and-beverage-related facility registered in advance by the user, compare a desired order time and order content specified by the user with the business hour information to determine whether the desired order time is included in the business hour information, generate a prompt sentence for generating online order information including an orderable time slot and the order content, input the prompt sentence into the generative AI model to obtain order execution parameters, and automatically execute an order process for an online order function of the food-and-beverage-related facility based on the order execution parameters, and
store, in the data storage device, scheduling rules and automatic processing conditions for associating the notification data from the education-related facility, the consultation time information of the medical-related facilities, the business hour information of the food-and-beverage-related facilities, schedule information of the user, and output results obtained from the generative AI model with one another, and perform cooperative control of the reservation process for the medical-related facility and the order process for the food-and-beverage-related facility based on the scheduling rules and the automatic processing conditions.

### (Supplementary 2)

The system according to supplementary 1,
wherein the processor is configured to
execute, while the user is performing another task, the reservation process and the order process automatically by using a scheduler function operating as a background task on an operating system, and to start processing in accordance with the scheduling rules and the automatic processing conditions periodically or in an event-driven manner.

### (Supplementary 3)

The system according to supplementary 1,
wherein the processor is configured to
use, as input, the notification data from the education-related facility, the voice data or the text data of the user, and an instruction sentence in natural language from the user, generate a prompt sentence including the notification data, the voice data or the text data, and the instruction sentence, input the prompt sentence into the generative AI model to obtain structured data including a determination result regarding presence or degree of the child's health condition, the emotion analysis result regarding the emotional state of the user, and selection conditions for the medical-related facility or the food-and-beverage-related facility, and determine, based on the structured data, executability, execution time, and a target facility for the reservation process for the medical-related facility and the order process for the food-and-beverage-related facility.

### Example 2

### (Supplementary 1)

A system comprising a processor,
wherein the processor is configured to
receive, via a communication network, notification information from an educational institution, normalize the notification information, and store the normalized notification information as internal data in a storage device,
extract, from the notification information, a child attribute, a symptom attribute, and an urgency attribute by performing rule-based analysis processing and natural language analysis processing using a generative AI model, and generate structured data including the child attribute, the symptom attribute, and the urgency attribute,
associate the child attribute included in the structured data with child information and guardian information stored in a user information storage device, and identify a guardian terminal and a communication route,
select, based on the symptom attribute and the urgency attribute included in the structured data and on medical facility information stored in a facility information storage device, one or more medical facility candidates as treatment targets, in consideration of at least a specialty attribute, a location attribute, and a priority attribute,
acquire, for each of the medical facility candidates, consultation time information and reservable time information via an external reservation-information-providing interface of a reservation-information-providing server, and generate time-slot information normalized into a standard format,
extract, from the time-slot information, time slots that are reservable within consultation hours, based on time-constraint information and position information included in the guardian information, rank a plurality of candidate time slots by using an evaluation function that considers at least the urgency attribute and travel time, and automatically select an optimal reservation candidate time slot,
generate a prompt sentence defining contents of reservation request data to be transmitted to a reservation-information-providing interface of a medical facility, based on the optimal reservation candidate time slot and the structured data, cause the generative AI model to generate the reservation request data on the basis of the prompt sentence, transmit the reservation request data to the reservation-information-providing interface, and execute a reservation process,
store, in a transaction information storage device, reservation identification information and consultation date-and-time information acquired as a result of execution of the reservation process in association with the structured data, generate a notification message including reservation results and consultation guidance for the guardian, and transmit the notification message to the guardian terminal via an electronic mail transmission apparatus or a notification delivery apparatus,
generate a prompt sentence for automatic payment of a medical fee, based on the result of the reservation process and medical fee information, cause the generative AI model to generate payment request data on the basis of the prompt sentence, transmit the payment request data to an electronic payment processing apparatus, and execute a payment process, and
generate audit information in which a series of processing contents, transmission and
reception contents with external interfaces, and input and output contents of the generative AI model are associated with one another, and store the audit information in an audit information storage device.

### (Supplementary 2)

The system according to supplementary 1,
wherein the processor is configured to
execute the reservation process and the payment process as a background process on the communication network without dependence on an operation from a user terminal, so that a guardian is enabled to have a reservation made while the guardian is performing another task.

### (Supplementary 3)

The system according to supplementary 1,
wherein the processor is configured to
obtain voice data or text data from a guardian, generate a prompt sentence for determining an emotional state of the guardian based on the voice data or the text data, input the prompt sentence and the voice data or the text data to the generative AI model, obtain an emotion analysis result from the generative AI model, and dynamically change the evaluation function or a selection condition for selecting the medical facility candidates and the optimal reservation candidate time slot based on the emotion analysis result.

### Application Example 2

### (Supplementary 1)

A system comprising a processor,
wherein the processor is configured to
receive notification data from an educational organization via a communication network, analyze text information included in the notification data, and extract an event related to a health condition of a protected person as structured data, and
acquire time information including consultation time information and reservation reception time information of a plurality of medical-related facilities from a storage apparatus or an external information processing apparatus on the basis of the extracted event and information on the protected person, and store the acquired time information as a data set, and
perform time-range calculation processing on the data set including the time information to compare the consultation time information and the reservation reception time information, extract one or more reservation reception time candidates included in a consultation time range, and select an earliest reservation candidate time period from among the reservation reception time candidates in accordance with a predetermined condition, and
generate a reservation-request prompt sentence on the basis of the selected reservation candidate time period and corresponding medical-related facility information, and transmit the reservation-request prompt sentence to an external reservation processing apparatus or a reservation service so as to cause execution of reservation processing, and
obtain voice data or text data of a user from a user terminal, perform a conversion process to convert the voice data into text data by speech recognition processing, generate an emotion-estimation prompt sentence that gives the text data as input to a generative artificial intelligence model for emotion estimation, and identify an emotion state as emotion type information obtained from the generative artificial intelligence model, and
refer to attribute information including at least one of evaluation information, waiting-time information, distance information, and congestion information by using the emotion state and the medical-related facility information as input, apply a selection rule that prioritizes at least one of consultation quality, waiting-time shortening, and congestion avoidance in accordance with the emotion state, specify an optimal medical-related facility, and generate a reservation prompt sentence reflecting a result of the specification, and
after completion of the reservation processing, communicate with an electronic payment processing apparatus by using fee information relating to a consultation and user payment information, generate a payment prompt sentence including a payment request, transmit the payment prompt sentence so as to cause automatic execution of payment processing for the consultation fee, and acquire and record payment result information, and
select a notification method from among electronic mail notification, short-range wireless communication notification, voice-call notification, and terminal-screen-display notification on the basis of the emotion state, generate notification content including at least one of a reservation result and a payment result, and transmit the notification content to the user terminal, and
cause the reservation result and the payment result to be displayed on the user terminal and accept a confirmation operation from the user.

### (Supplementary 2)

The system according to supplementary 1,
wherein the processor is configured to execute, by using an asynchronous processing
mechanism, at least one of an acquiring process of the consultation time information and the reservation reception time information, the time-range calculation processing, the reservation processing, the electronic payment processing, and a notification processing, in parallel with work processing by the user without interrupting an operation on the user terminal.

### (Supplementary 3)

The system according to supplementary 1,
wherein the processor is configured to generate, on the basis of the voice data or the text data of the user, an emotion-analysis prompt sentence for calling the generative artificial intelligence model, extract only the emotion type information from a text response returned from the generative artificial intelligence model to determine the emotion state, and change at least one of a selection rule of the reservation candidate time period and a selection rule of the notification method in accordance with the determined emotion state.

What is claimed is:

1. A system comprising:
circuitry configured to:
receive, via a communication interface coupled to a packet-switched network, condition data from an external institution, transform the condition data into structured data, and store the structured data in a storage device;
access attribute data for a plurality of service providers stored in the storage device, acquire operation data comprising available time periods and reservable time periods for the service providers based on the condition data and location data associated with a subject individual;
apply a scoring algorithm to the available time periods to select an optimal time period according to at least one evaluation rule, generate reservation generation data comprising the selected time period and a service provider identifier, and execute a reservation confirmation process by transmitting a reservation request to an external reservation management apparatus and receiving confirmation data;
generate notification data comprising the confirmation data and transmit the notification data to a terminal device via the communication interface;
receive, via the communication interface, at least one of audio data or character data from the terminal device, construct an emotion analysis prompt sentence encoding the at least one of audio data or character data together with contextual data comprising a portion of the structured data, the operation data, and interaction history data, transmit the emotion analysis prompt sentence to a generative neural network model, and receive an emotion analysis result from the generative neural network model; and
dynamically modify at least one of the evaluation rule for the scoring algorithm, a service provider selection condition, a notification format, or a processing timing, based on the emotion analysis result.

2. The system according to claim 1, wherein the circuitry is configured to execute a background process that monitors incoming condition data via the communication interface, triggers the scoring algorithm and reservation confirmation process without requiring active user interaction, and transmits the notification data to the terminal device upon completion of the reservation confirmation process.

3. The system according to claim 2, wherein the circuitry is configured to apply the scoring algorithm by computing a composite score for each available time period based on a weighted combination of a proximity metric, an availability metric, and a provider attribute metric, and selecting the time period with the highest composite score.

4. The system according to claim 3, wherein the circuitry is configured to adjust weights of the weighted combination based on the emotion analysis result by increasing the weight of the proximity metric when the emotion analysis result indicates an elevated stress state parameter, and decreasing the weight of the provider attribute metric when the emotion analysis result indicates a time-urgency state parameter.

5. The system according to claim 4, wherein the circuitry is configured to receive updated condition data indicating a change in status of the subject individual, regenerate the scoring algorithm evaluation using the updated condition data, and transmit an updated reservation generation data or a notification of status change to the terminal device.

6. The system according to claim 1, wherein the circuitry is configured to construct the emotion analysis prompt sentence by selecting a prompt template based on a data type parameter of the at least one of audio data or character data, substituting the encoded audio data or character data and the contextual data into the prompt template, and appending analysis instruction specifications.

7. The system according to claim 6, wherein the circuitry is configured to apply a speech recognition model to the audio data to generate a character string transcription, apply a sentiment analysis model to the character string transcription to generate a preliminary sentiment score, and incorporate the preliminary sentiment score as additional input to the emotion analysis prompt sentence.

8. The system according to claim 7, wherein the circuitry is configured to compare the emotion analysis result against a distress threshold, generate an alert message when the emotion analysis result exceeds the distress threshold, and transmit the alert message to the terminal device with higher transmission priority than the notification data.

9. The system according to claim 1, wherein the circuitry is configured to determine fee data related to the service based on the confirmation data, construct a settlement processing prompt sentence incorporating the fee data and payment method data stored in the storage device, transmit the settlement processing prompt sentence to the generative neural network model, and receive settlement execution instructions for transmitting to an electronic settlement system via the communication interface.

10. The system according to claim 9, wherein the circuitry is configured to receive settlement confirmation data from the electronic settlement system, store the settlement confirmation data in the storage device in association with the reservation generation data, and transmit a settlement notification to the terminal device.

11. The system according to claim 1, wherein the circuitry is configured to maintain, in the storage device, interaction history data recording prior condition data, emotion analysis results, and selected service provider identifiers, and incorporate the interaction history data as contextual data in subsequent emotion analysis prompt sentences to improve the accuracy of emotion analysis results.

12. The system according to claim 11, wherein the circuitry is configured to apply a pattern extraction algorithm to the stored interaction history data to identify recurring state parameters, adjust the evaluation rule weights of the scoring algorithm based on the identified recurring state parameters, and store the adjusted evaluation rule weights in the storage device for use in subsequent scoring algorithm executions.

13. The system according to claim 1, wherein the circuitry is configured to generate a plurality of candidate reservation generation data items by applying the scoring algorithm to a plurality of available time periods, transmit a ranked list of the candidate reservation generation data items to the terminal device, and receive a selection input from the terminal device indicating a selected item from the ranked list.

14. The system according to claim 13, wherein the circuitry is configured to incorporate the user selection input and associated emotion analysis result into the interaction history data, apply a reinforcement update to the evaluation rule weights based on the selection input, and store the updated evaluation rule weights in the storage device.

15. The system according to claim 1, wherein the circuitry is configured to generate a multi-modal notification by combining text notification data with audio notification data generated by a speech synthesis model applied to the text notification data, and transmit the multi-modal notification to the terminal device via at least one of a push notification channel, a short message channel, or an electronic mail channel.

16. The system according to claim 15, wherein the circuitry is configured to adjust a tone parameter and speech rate of the audio notification data based on the emotion analysis result, and regenerate the audio notification data with the adjusted tone parameter and speech rate prior to transmission.

17. The system according to claim 1, wherein the circuitry is configured to monitor an availability status of the external reservation management apparatus via the communication interface, detect an unavailability condition of the external reservation management apparatus, and apply a fallback scoring algorithm to select an alternative service provider from the attribute data stored in the storage device when the unavailability condition is detected.

18. A system comprising:
circuitry configured to:
receive, via a communication interface coupled to a packet-switched network, condition data from an external institution, transform the condition data into structured data, and access operation data for a plurality of service providers from a storage device;
apply a scoring algorithm to available time periods derived from the operation data to select an optimal time period, generate reservation generation data, and execute a reservation confirmation process with an external reservation management apparatus via the communication interface;
receive at least one of audio data or character data from a terminal device, construct an emotion analysis prompt sentence encoding the received data and contextual data, transmit the emotion analysis prompt sentence to a generative neural network model, and receive an emotion analysis result; and
dynamically modify at least one of an evaluation rule for the scoring algorithm or a service provider selection condition based on the emotion analysis result, and transmit notification data comprising confirmation data to the terminal device.

19. The system according to claim 18, wherein the circuitry is configured to determine fee data based on the confirmation data, construct a settlement processing prompt sentence incorporating the fee data and payment method data, transmit the settlement processing prompt sentence to the generative neural network model, receive settlement execution instructions, and transmit the settlement execution instructions to an electronic settlement system.

20. A method performed by circuitry, the method comprising:
receiving, via a communication interface coupled to a packet-switched network, condition data from an external institution, transforming the condition data into structured data, and storing the structured data in a storage device;
accessing attribute data for a plurality of service providers stored in the storage device, acquiring operation data comprising available time periods and reservable time periods for the service providers based on the condition data and location data associated with a subject individual;
applying a scoring algorithm to the available time periods to select an optimal time period according to at least one evaluation rule, generating reservation generation data comprising the selected time period and a service provider identifier, and executing a reservation confirmation process by transmitting a reservation request to an external reservation management apparatus and receiving confirmation data;
generating notification data comprising the confirmation data and transmitting the notification data to a terminal device via the communication interface;
receiving, via the communication interface, at least one of audio data or character data from the terminal device, constructing an emotion analysis prompt sentence encoding the at least one of audio data or character data together with contextual data comprising a portion of the structured data, the operation data, and interaction history data, transmitting the emotion analysis prompt sentence to a generative neural network model, and receiving an emotion analysis result from the generative neural network model; and
dynamically modifying at least one of the evaluation rule for the scoring algorithm, a service provider selection condition, a notification format, or a processing timing, based on the emotion analysis result.
